(19) United States
(12) Patent Application Publication
(10) Pub. No.: US 2008/0155661 A1
(43) Pub. Date: Jun. 26, 2008

(54) AUTHENTICATION SYSTEM AND MAIN TERMINAL

(75) Inventors: Nobuhiko ARASHIN, Osaka (JP); Osamu TANAKA, Osaka (JP); Hiroyuki WATANABE, Osaka (JP); Toyoshi YAMADA, Osaka (JP); Masahiko NAGOSHI, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/961,115

(22) Filed: Dec. 20, 2007

(30) Foreign Application Priority Data
Dec. 25, 2006 (JP) 2006-348535

(51) Int. Cl. H04L 9/00

(52) U.S. Cl. 726/4

(57) ABSTRACT

An authentication system includes: a main terminal; one or more sub-terminals connected to the main terminal; and an authentication server connected to the main terminal. The authentication server authenticates whether the sub-terminal is a terminal for which communication permission is granted by exchanging authentication data with the sub-terminal via the main terminal.

### BACKGROUND OF THE INVENTION

1. Field of the Invention

The present invention relates to an authentication system of network devices connected to a network and a main terminal.

2. Related Art of the Invention

In a communication system, performing authentication of communication devices is critically important in order to prevent unauthorized use. However, when attempting to achieve authentication of all communication devices connected on a system through a server, there is a problem in that load concentration occurs on the server performing authentication.

With respect to this problem, for example, a method for avoiding load concentration due to authentication or the like in a communication system has been proposed (for example, refer to Japanese Patent Laid-Open No. 2003-318939).

FIG. 13 shows a connection configuration diagram of a conventional communication system disclosed in Japanese Patent Laid-Open No. 2003-318939.

A DHCP (Dynamic Host Configuration Protocol) server 102 allocates an IP address to a terminal attempting to access a network 101. A HP (Home Page) server 103 provides terminals connected to the network 101 with services such as web browsing and data base access. The HP server 103 is a server that can only be used by client terminals authenticated by the DHCP server 102.

On the other hand, wireless client terminals 106 to 108 are connected to the network 101 via an access point 105. Each wireless client terminal 106 to 108 is constituted by a user terminal such as a PC (Personal Computer) and a wireless LAN (Local Area Network) adapter. User terminals 113 to 115 respectively use wireless LAN adapters 110 to 112 to connect to the access point 105 by wireless, and connect to the network 101 via the access point 105.

In this case, the access point 105 is provided with a registered address list 104 in which MAC (Media Access Control) addresses of wireless client terminals that may potentially be granted access permissions to the network 101 are registered.

For example, when the wireless client terminal 106 requests address allocation, the wireless client terminal 106 is first granted permission for physical layer connection from the access point 105 and establishes a link with the access point 105. After establishing the link, the wireless client terminal 106 transmits an address allocation request message including its own MAC address, which is first received at the access point 105. The access point 105 extracts the MAC address from the received address allocation request message, and analyzes whether the MAC address is registered in the registered address list 104.

When the MAC address is unregistered, the access point 105 suspends and concludes IP address allocation. In other words, in this case, the address allocation request message from the wireless client terminal 106 is not transmitted to the DHCP server 102, and IP address allocation for the wireless client terminal 106 does not occur at the DHCP server 102.

Meanwhile, when the MAC address is registered, the access point 105 transmits the address allocation request message from the wireless client terminal 106 to the DHCP server 102.

In other words, terminal authentication by MAC addresses on the wireless client terminals 106 to 108 to be connected by wireless to the access point 105 is performed not by the DHCP server 102 but at the access point 105 instead.

Although not shown in FIG. 13, terminal authentication on client terminals wire-connected to the network 101 is performed by the DHCP server 102, which also performs IP address allocation.

In this manner, by having the access point 105 perform determination conventionally performed by the DHCP server 102 on whether or not to accommodate the wireless client terminals 106 to 108, unauthorized access is prevented and, at the same time, the load due to address allocation and authentication concentrating on the DHCP server 102 is distributed.

However, with the conventional communication system shown in FIG. 13, since a band is allocated for determination performed by the access point 105 even when an address allocation request from an unauthorized client terminal is denied by the access point 105, bands used by authorized client terminals are eventually occupied.

In other words, even for an address allocation request from an unauthorized wireless client terminal, the access point 105 grants permission for physical layer connection and allocates a band to receive the address allocation request from the wireless client terminal and analyze the contents of the message.

In this manner, drawbacks occur from the perspective of a user of an authorized wireless access terminal, as exemplified by the occupation of bands that normally should have been allocated to authorized wireless client terminals due to band allocation for determining whether or not to accommodate an unauthorized wireless client terminal which in turn causes a reduction in transfer speed during the period required for such determination.

The present invention has been made in consideration of the above problem, and an object thereof is to provide an authentication system and a main terminal capable of reducing the load on an authentication server without straining bands used by authorized wireless client terminals.

### SUMMARY OF THE INVENTION

The present invention provides an authentication system and a main terminal capable of reducing the load on an authentication server through management that is simpler than before.

The first aspect of the present invention is an authentication system comprising:

a main terminal;

one or more sub-terminals connected to the main terminal; and

an authentication server connected to the main terminal and which authenticates whether the sub-terminal is a terminal for which communication permission is granted by exchanging authentication data with the sub-terminal via the main terminal, wherein

the main terminal includes:

a connection control unit that controls physical layer connection with the sub-terminal;

an authentication state table for storing at least ID information of the sub-terminal included in authentication request data transmitted by the sub-terminal to the authentication server when making an authentication request; and

an authentication state control unit which, in the event that an authentication result included in authentication response data transmitted to the sub-terminal by the authentication server in correspondence to the authentication request data transmitted by the sub-terminal to the authentication server indicates that the sub-terminal corresponding to the ID information stored in the authentication state table is a terminal for which permission is denied, causes the connection control unit to disconnect the physical layer connection with the sub-terminal so as to disable link establishment from the sub-terminal.

The second aspect of the present invention is an authentication system comprising:

a main terminal;

one or more sub-terminals connected to the main terminal; and

an authentication server connected to the main terminal and which authenticates whether a sub-terminal is a terminal for which communication permission is granted by exchanging authentication data with the sub-terminal via the main terminal, wherein

the sub-terminal is arranged so that when the sub-terminal establishes a new link with the main terminal, the sub-terminal transmits authentication request data for requesting authentication to the authentication server within a predetermined authentication request timeout period after establishing the link, and

the main terminal includes:

a connection detection unit that detects a connection state with the sub-terminal;

a connection control unit that controls physical layer connection with the sub-terminal; and

an authentication state control unit which, after the connection detection unit detects that a link with the sub-terminal has been newly established, the sub-terminal fails to transmit the authentication request data intended for the authentication server within the predetermined authentication request timeout period, causes the connection control unit to disconnect the physical layer connection with the sub-terminal so as to disable link establishment from the sub-terminal.

The third aspect of the present invention is an authentication system comprising:

a main terminal;

one or more sub-terminals connected to the main terminal; and

an authentication server connected to the main terminal and which authenticates whether a sub-terminal is a terminal for which communication permission is granted by exchanging authentication data with the sub-terminal via the main terminal, wherein

the sub-terminal is arranged so that in the event that an authentication result included in authentication response data received from the authentication server is that of denied permission, after receiving the authentication response data, the sub-terminal disconnects the link with the main terminal within a predetermined denied permission reception timeout period, and

the main-terminal includes:

a connection detection unit that detects a connection state with the sub-terminal;

a connection control unit that controls physical layer connection with the sub-terminal;

an authentication state table for storing at least ID information of the sub-terminal included in authentication request data transmitted by the sub-terminal to the authentication server when making an authentication request; and

an authentication state control unit which, in the event that an authentication result included in the authentication response data transmitted to the sub-terminal by the authentication server in correspondence to the authentication request data transmitted by the sub-terminal to the authentication server indicates that the sub-terminal corresponding to the ID information stored in the authentication state table is a terminal for which permission is denied, the authentication state control unit forwards the authentication response data to the sub-terminal, and when the sub-terminal subsequently fails to disconnect the link within the predetermined denied permission reception timeout period, the authentication state control unit causes the connection control unit to disconnect the physical layer connection with the sub-terminal so as to disable link establishment from the sub-terminal.

The fourth aspect of the present invention is the authentication system according to the third aspect of the present invention, wherein

the sub-terminal includes a frequency control unit that controls an operating frequency used in communication, and

upon receiving the authentication response data in which the authentication result is that of denied permission, the sub-terminal disconnects the link established up to that point with the main terminal in order to connect with another main terminal operating at a different operating frequency.

The fifth aspect of the present invention is an authentication system comprising:

a main terminal;

one or more sub-terminals connected to the main terminal; and

an authentication server connected to the main terminal and which authenticates whether a sub-terminal is a terminal for which communication permission is granted by exchanging authentication data with the sub-terminal via the main terminal, wherein

the sub-terminal is arranged so that in the event in which, after transmitting authentication request data to the authentication server in order to request authentication, the sub-terminal does not receive authentication response data corresponding to the authentication request data from the authentication server within a predetermined retry request period, the sub-terminal retransmits the authentication request data for a predetermined number of retries within each predetermined retry request period, and in the event that the authentication response data is still not received, the sub-terminal disconnects the link with the main terminal within a predetermined authentication response timeout period starting at the time point of transmission of the first authentication request data, and

the main terminal includes:

a connection detection unit that detects a connection state with the sub-terminal;

a connection control unit that controls physical layer connection with the sub-terminal; and

an authentication state control unit which, in the event that after transferring the first authentication request data from the sub-terminal to the authentication server, the link with the sub-terminal is not disconnected even though the authentication response data intended for the sub-terminal has not been transmitted from the authentication server within the predetermined authentication reception timeout period, causes the connection control unit to disconnect the physical layer connection with the sub-terminal so as to disable link establishment from the sub-terminal.

The sixth aspect of the present invention is the authentication system according to the fifth aspect of the present invention, wherein

the sub-terminal includes a frequency control unit that controls an operating frequency used in communication, and

when the sub-terminal does not receive the authentication response data despite retransmitting the authentication request data for the predetermined number of retries, the sub-terminal disconnects the link established up to that point with the main terminal in order to connect with another main terminal operating at a different operating frequency.

The seventh aspect of the present invention is the authentication system according to the first aspect of the present invention, wherein

the main terminal includes a speed limiting unit capable of limiting the communication speed between the sub-terminal to a slower speed, and

the authentication state control unit is arranged so that, subsequent to detection of an establishment of a new link with the sub-terminal by the connection detection unit and until the sub-terminal is authenticated by the authentication server, the authentication state control unit controls the speed limiting unit so that the communication speed between the main terminal and the sub-terminal becomes slower.

The eighth aspect of the present invention is the authentication system according to the second aspect of the present invention, wherein

the main terminal includes a speed limiting unit capable of limiting the communication speed between the sub-terminal to a slower speed, and

the authentication state control unit is arranged so that, subsequent to detection of an establishment of a new link with the sub-terminal by the connection detection unit and until the sub-terminal is authenticated by the authentication server, the authentication state control unit controls the speed limiting unit so that the communication speed between the main terminal and the sub-terminal becomes slower.

The ninth aspect of the present invention is the authentication system according to the third aspect of the present invention, wherein

the main terminal includes a speed limiting unit capable of limiting the communication speed between the sub-terminal to a slower speed, and

the authentication state control unit is arranged so that, subsequent to detection of an establishment of a new link with the sub-terminal by the connection detection unit and until the sub-terminal is authenticated by the authentication server, the authentication state control unit controls the speed limiting unit so that the communication speed between the main terminal and the sub-terminal becomes slower.

The tenth aspect of the present invention is the authentication system according to the fifth aspect of the present invention, wherein

the main terminal includes a speed limiting unit capable of limiting the communication speed between the sub-terminal to a slower speed, and

the authentication state control unit is arranged so that, subsequent to detection of an establishment of a new link with the sub-terminal by the connection detection unit and until the sub-terminal is authenticated by the authentication server, the authentication state control unit controls the speed limiting unit so that the communication speed between the main terminal and the sub-terminal becomes slower.

The eleventh aspect of the present invention is the authentication system according to the first aspect of the present invention, comprising

a terminal management apparatus connected to the main terminal and which manages the main terminal and the sub-terminal, wherein

the main terminal includes an unauthorized terminal notification unit which, in the case where the physical layer connection with the sub-terminal is disconnected, assumes that the sub-terminal is an unauthorized terminal and notifies information on the sub-terminal to the terminal management apparatus.

The twelfth aspect of the present invention is the authentication system according to the second aspect of the present invention, comprising

a terminal management apparatus connected to the main terminal and which manages the main terminal and the sub-terminal, wherein

the main terminal includes an unauthorized terminal notification unit which, in the case where the physical layer connection with the sub-terminal is disconnected, assumes that the sub-terminal is an unauthorized terminal and notifies information on the sub-terminal to the terminal management apparatus.

The thirteenth aspect of the present invention is the authentication system according to the third aspect of the present invention, comprising

a terminal management apparatus connected to the main terminal and which manages the main terminal and the sub-terminal, wherein

the main terminal includes an unauthorized terminal notification unit which, in the case where the physical layer connection with the sub-terminal is disconnected, assumes that the sub-terminal is an unauthorized terminal and notifies information on the sub-terminal to the terminal management apparatus.

The fourteenth aspect of the present invention is the authentication system according to the fifth aspect of the present invention, comprising

a terminal management apparatus connected to the main terminal and which manages the main terminal and the sub-terminal, wherein

the main terminal includes an unauthorized terminal notification unit which, in the case where the physical layer connection with the sub-terminal is disconnected, assumes that the sub-terminal is an unauthorized terminal and notifies information on the sub-terminal to the terminal management apparatus.

The fifteenth aspect of the present invention is the authentication system according to the first aspect of the present invention, wherein

the main terminal includes:

an authentication request data creation unit that creates authentication request data for having the authentication server authenticate the main terminal itself; and

an authentication response data analysis unit that analyzes authentication response data received from the authentication server which corresponds to the authentication request data for having the main terminal itself authenticated, wherein

the authentication response data analysis unit starts transfer control between the authentication server and the sub-terminal after the main terminal itself is authenticated by the authentication server.

The sixteenth aspect of the present invention is the authentication system according to the second aspect of the present invention, wherein

the main terminal includes:

an authentication request data creation unit that creates authentication request data for having the authentication server authenticate the main terminal itself; and

an authentication response data analysis unit that analyzes authentication response data received from the authentication server which corresponds to the authentication request data for having the main terminal itself authenticated, wherein

the authentication response data analysis unit starts transfer control between the authentication server and the sub-terminal after the main terminal itself is authenticated by the authentication server.

The seventeenth aspect of the present invention is the authentication system according to the third aspect of the present invention, wherein

the main terminal includes:

an authentication request data creation unit that creates authentication request data for having the authentication server authenticate the main terminal itself; and

an authentication response data analysis unit that analyzes authentication response data received from the authentication server which corresponds to the authentication request data for having the main terminal itself authenticated, wherein

the authentication response data analysis unit starts transfer control between the authentication server and the sub-terminal after the main terminal itself is authenticated by the authentication server.

The eighteenth aspect of the present invention is the authentication system according to the fifth aspect of the present invention, wherein

the main terminal includes:

an authentication request data creation unit that creates authentication request data for having the authentication server authenticate the main terminal itself; and

an authentication response data analysis unit that analyzes authentication response data received from the authentication server which corresponds to the authentication request data for having the main terminal itself authenticated, wherein

the authentication response data analysis unit starts transfer control between the authentication server and the sub-terminal after the main terminal itself is authenticated by the authentication server.

The nineteenth aspect of the present invention is the authentication system according to the fifteenth aspect of the present invention, wherein

the main terminal includes an authentication necessity switching unit that sets the necessity of authentication of the main terminal itself, wherein

when the authentication necessity switching unit is set so that authentication of the main terminal itself is not performed, the authentication response data analysis unit causes transfer of authentication data to be exchanged between the authentication server and the sub-terminal to be performed without performing processing for authentication.

The twentieth aspect of the present invention is the authentication system according to the sixteenth aspect of the present invention, wherein

the main terminal includes an authentication necessity switching unit that sets the necessity of authentication of the main terminal itself, wherein

when the authentication necessity switching unit is set so that authentication of the main terminal itself is not performed, the authentication response data analysis unit causes transfer of authentication data to be exchanged between the authentication server and the sub-terminal to be performed without performing processing for authentication.

The twenty-first aspect of the present invention is the authentication system according to the seventeenth aspect of the present invention, wherein

the main terminal includes an authentication necessity switching unit that sets the necessity of authentication of the main terminal itself, wherein

when the authentication necessity switching unit is set so that authentication of the main terminal itself is not performed, the authentication response data analysis unit causes transfer of authentication data to be exchanged between the authentication server and the sub-terminal to be performed without performing processing for authentication.

The twenty-second aspect of the present invention is the authentication system according to the eighteenth aspect of the present invention, wherein

the main terminal includes an authentication necessity switching unit that sets the necessity of authentication of the main terminal itself, wherein

when the authentication necessity switching unit is set so that authentication of the main terminal itself is not performed, the authentication response data analysis unit causes transfer of authentication data to be exchanged between the authentication server and the sub-terminal to be performed without performing processing for authentication.

The twenty-third aspect of the present invention is the authentication system according to the first aspect of the present invention, wherein

the connection detection unit acquires a MAC address of the sub-terminal upon establishment of the link with the sub-terminal, and

the authentication state control unit notifies the MAC address of a sub-terminal for which a physical layer connection is to be disconnected to the connection control unit in order to disconnect the physical layer connection with the sub-terminal.

The twenty-fourth aspect of the present invention is the authentication system according to the second aspect of the present invention, wherein

the connection detection unit acquires a MAC address of the sub-terminal upon establishment of the link with the sub-terminal, and

the authentication state control unit notifies the MAC address of a sub-terminal for which a physical layer connection is to be disconnected to the connection control unit in order to disconnect the physical layer connection with the sub-terminal.

The twenty-fifth aspect of the present invention is the authentication system according to the third aspect of the present invention, wherein

the connection detection unit acquires a MAC address of the sub-terminal upon establishment of the link with the sub-terminal, and

the authentication state control unit notifies the MAC address of a sub-terminal for which a physical layer connection is to be disconnected to the connection control unit in order to disconnect the physical layer connection with the sub-terminal.

The twenty-sixth aspect of the present invention is the authentication system according to the fifth aspect of the present invention, wherein

the connection detection unit acquires a MAC address of the sub-terminal upon establishment of the link with the sub-terminal, and

the authentication state control unit notifies the MAC address of a sub-terminal for which a physical layer connection is to be disconnected to the connection control unit in order to disconnect the physical layer connection with the sub-terminal.

The twenty-seventh aspect of the present invention is the authentication system according to the first aspect of the present invention, wherein the main terminal and the sub-terminal is connected by a coaxial cable via a distributor.

The twenty-eighth aspect of the present invention is the authentication system according to the second aspect of the present invention, wherein the main terminal and the sub-terminal is connected by a coaxial cable via a distributor.

The twenty-ninth aspect of the present invention is the authentication system according to the third aspect of the present invention, wherein the main terminal and the sub-terminal is connected by a coaxial cable via a distributor.

The thirtieth aspect of the present invention is the authentication system according to the fifth aspect of the present invention, wherein the main terminal and the sub-terminal is connected by a coaxial cable via a distributor.

The thirty-first aspect of the present invention is the main terminal connected between an authentication server that authenticates a sub-terminal by exchanging authentication data and the sub-terminal, and which transfers the authentication data between the authentication server and the sub-terminal, the main terminal comprising:

a connection control unit that controls physical layer connection with the sub-terminal;

an authentication state table for storing at least ID information of the sub-terminal included in authentication request data transmitted by the sub-terminal to the authentication server when making an authentication request; and

an authentication state control unit which, in the event that an authentication result included in authentication response data transmitted to the sub-terminal by the authentication server in correspondence to the authentication request data transmitted by the sub-terminal to the authentication server indicates that the sub-terminal corresponding to the ID information stored in the authentication state table is a terminal for which permission is denied, causes the connection control unit to disconnect the physical layer connection with the sub-terminal so as to disable link establishment from the sub-terminal.

The thirty-second aspect of the present invention is an authentication method of a sub-terminal using a main terminal, one or more sub-terminals connected to the main terminal, and an authentication server connected to the main terminal and which authenticates whether the sub-terminal is a terminal for which communication permission is granted by exchanging authentication data with the sub-terminal via the main terminal, wherein the authentication method comprises the steps performed by the main terminal of:

connection control step for controlling physical layer connection with the sub-terminal;

authentication state storage step for storing at least ID information of the sub-terminal included in authentication request data transmitted by the sub-terminal to the authentication server when making an authentication request; and

authentication state control step for, in the event that an authentication result included in authentication response data transmitted to the sub-terminal by the authentication server in correspondence to the authentication request data transmitted by the sub-terminal to the authentication server indicates that the sub-terminal corresponding to the ID information stored in the authentication state table is a terminal for which permission is denied, causing the physical layer connection with the sub-terminal to be disconnected in the connection control step so as to disable link establishment from the sub-terminal.

Thirty-third aspect of the present invention is an authentication method of a sub-terminal using a main terminal, one or more sub-terminals connected to the main terminal, and an authentication server connected to the main terminal and which authenticates whether a sub-terminal is a terminal for which communication permission is granted by exchanging authentication data with the sub-terminal via the main terminal, wherein the authentication method comprises

a step performed by the sub-terminal of:

transmitting, when the sub-terminal establishes a new link with the main terminal, authentication request data for requesting authentication to the authentication server within a predetermined authentication request timeout period after establishing the link, and

the steps performed by the main terminal of:

connection detection step for detecting a connection state with the sub-terminal;

connection control step for controlling physical layer connection with the sub-terminal; and

authentication state control step for causing, in the case where after a new establishment of a link with the sub-terminal is detected in the connection detection step, the sub-terminal fails to transmit the authentication request data intended for the authentication server within the predetermined authentication request timeout period, the physical layer connection with the sub-terminal to be disconnected in the connection control step so as to disable link establishment from the sub-terminal.

Thirty-fourth aspect of the present invention is an authentication method of a sub-terminal using a main terminal, one or more sub-terminals connected to the main terminal, and an authentication server connected to the main terminal and which authenticates whether a sub-terminal is a terminal for which communication permission is granted by exchanging authentication data with the sub-terminal via the main terminal, wherein the authentication method comprises

a step performed by the sub-terminal of:

disconnecting the link with the main terminal within a predetermined denied permission reception timeout period after receiving authentication response data from the authentication server in the event that an authentication result included in the received authentication response data is that of denied permission, and

the steps performed by the main terminal of:

connection detection for detecting a connection state with the sub-terminal;

connection control step for controlling physical layer connection with the sub-terminal;

authentication state storage step for storing at least ID information of the sub-terminal included in authentication request data transmitted by the sub-terminal to the authentication server when making an authentication request; and

authentication state control step for, in the event that an authentication result included in the authentication response data transmitted to the sub-terminal by the authentication server in correspondence the authentication request data transmitted by the sub-terminal to the authentication server indicates that the sub-terminal corresponding to the ID information stored in the authentication state table is a terminal for which permission is denied, forwarding the authentication response data to the sub-terminal, and when the sub-terminal subsequently fails to disconnect the link within a predetermined denied permission reception timeout period, causing the physical layer connection with the sub-terminal to be disconnected in the connection control step so as to disable link establishment from the sub-terminal.

The thirty-fifth aspect of the present invention is an authentication method of a sub-terminal using a main terminal, one or more sub-terminals connected to the main terminal, and an authentication server connected to the main terminal and which authenticates whether a sub-terminal is a terminal for which communication permission is granted by exchanging authentication data with the sub-terminal via the main terminal, wherein the authentication method comprises

a step performed by the sub-terminal of:

in the event that, after transmitting authentication request data to the authentication server in order to request authentication, the sub-terminal does not receive authentication response data corresponding to the authentication request data from the authentication server within the retry request period, retransmitting the authentication request data for a predetermined number of retries within each predetermined retry request period, and in the event that the authentication response data is thereafter still not received, disconnecting the link with the main terminal within a predetermined authentication reception timeout period from the time point of transmission of the first authentication request data

and the steps performed by the main terminal of:

connection detection step for detecting a connection state with the sub-terminal;

connection control step for controlling physical layer connection with the sub-terminal; and

authentication state control step for, in the event that after transferring the first authentication request data from the sub-terminal to the authentication server, the link with the sub-terminal is not disconnected even though the authentication response data intended for the sub-terminal has not been transmitted from the authentication server within the predetermined authentication reception timeout period, causing the physical layer connection with the sub-terminal to be disconnected in the connection control step so as to disable link establishment from the sub-terminal.

The thirty-sixth aspect of the present invention is an authentication method that controls authentication of a sub-terminal by transferring, between an authentication server that authenticates a sub-terminal by exchanging authentication data and the sub-terminal, the authentication data between the authentication server and the sub-terminal, the method comprising the steps of:

connection control step for controlling physical layer connection with the sub-terminal;

authentication state storage step for storing at least ID information of the sub-terminal included in authentication request data transmitted by the sub-terminal to the authentication server when making an authentication request; and

authentication state control step for, in the event that an authentication result included in authentication response data transmitted to the sub-terminal by the authentication server in correspondence to the authentication request data transmitted by the sub-terminal to the authentication server indicates that the sub-terminal corresponding to the ID information stored in the authentication state table is a terminal for which permission is denied, causing the physical layer connection with the sub-terminal to be disconnected in the connection control step so as to disable link establishment from the sub-terminal.

The thirty-seventh aspect of the present invention is a program on computer-readable medium, which acts as an main terminal according to the first aspect of the present invention, connected between an authentication server that authenticates a sub-terminal by exchanging authentication data and the sub-terminal, and which transfers the authentication data between the authentication server and the sub-terminal, the main terminal comprising:

the connection control unit that controls physical layer connection with the sub-terminal;

the authentication state table for storing at least ID information of the sub-terminal included in authentication request data transmitted by the sub-terminal to the authentication server when making an authentication request; and

the authentication state control unit which, in the event that an authentication result included in authentication response data transmitted to the sub-terminal by the authentication server in correspondence to the authentication request data transmitted by the sub-terminal to the authentication server indicates that the sub-terminal corresponding to the ID information stored in the authentication state table is a terminal for which permission is denied, causes the connection control unit to disconnect the physical layer connection with the sub-terminal so as to disable link establishment from the sub-terminal.

The thirty-eighth aspect of the present invention is a computer-readable recording medium for recording the program of the thirty-seventh aspect of the present invention.

### BRIEF DESCRIPTION OF THE DRAWINGS

FIG. 1 is a schematic configuration diagram of an authentication system according to a first embodiment of the present invention;

FIG. 2 is an internal configuration diagram of a main terminal according to the first embodiment of the present invention;

FIG. 3 is an internal configuration diagram of a cable modem according to the first embodiment of the present invention;

FIG. 4 is a diagram showing state transitions upon authentication of a sub-terminal managed by the main terminal according to the first embodiment of the present invention;

FIGS. 5A to 5D are diagrams showing state management tables of a sub-terminal managed by the main terminal according to the first embodiment of the present invention;

FIG. 6 is a diagram showing state transitions upon authentication of a sub-terminal managed by a main terminal according to a second embodiment of the present invention;

FIGS. 7A to 7D are diagrams showing state management tables of a sub-terminal managed by the main terminal according to the second embodiment of the present invention;

FIG. 8 is a diagram showing state transitions upon authentication of a sub-terminal managed by a main terminal according to a third embodiment of the present invention;

FIGS. 9A to 9D are diagrams showing state management tables of a sub-terminal managed by the main terminal according to the third embodiment of the present invention;

FIG. 10 is a diagram showing state transitions upon authentication of a sub-terminal managed by a main terminal according to a fourth embodiment of the present invention;

FIGS. 11A to 11D are diagrams showing state management tables of a sub-terminal managed by the main terminal according to the fourth embodiment of the present invention;

FIG. 12 is an internal configuration diagram of a main terminal according to a fifth embodiment of the present invention; and

FIG. 13 is a connection configuration diagram of a conventional communication system.

### DESCRIPTION OF SYMBOLS

10, 21 Communication I/F
11, 20 Coaxial I/F
12, 24 Authentication data analysis section
13 Authentication state storage section
14 Coaxial control section
15 Connection detection section
16, 26 Communication transmission/reception processing section
17, 25 Transfer control section
18 Communication data snooping section
19, 23 Coaxial transmission/reception processing section
22 Coaxial frequency control section
27 Authentication data creation section
28 Authentication ID storage section
29 State management table
31, 41, 51, 61 Unconnected state
32, 42, 52, 62 Authentication request wait state
33, 43, 53, 63 Authentication response wait state
34, 44, 54, 64 Authentication completed state
35, 45, 55, 65 Unauthorized/disconnect
56 Search wait state
71 Main terminal
72, 73, 74 Sub-terminal
75 Authentication server
76 Terminal management apparatus
77 Internet
78 Distributor
79, 80, 81 Coaxial cable modem
82, 83, 84 User terminal
85, 86, 87, 88 Coaxial cable
89 Optical fiber cable
92 Authentication data creation section
93 Authentication ID storage section
94 Unauthorized terminal notification section
95 Authentication management implementation necessity setting section

### PREFERRED EMBODIMENTS OF THE INVENTION

Embodiments of the present invention will now be described with reference to the drawings.

### First Embodiment

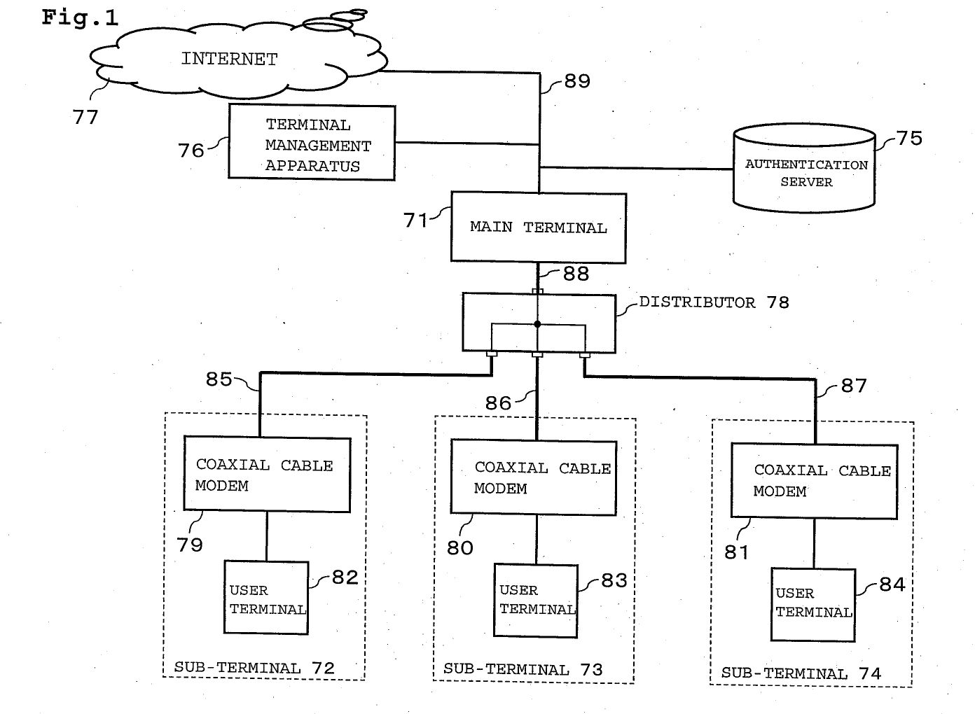

FIG. 1 is a configuration diagram schematically showing a configuration of an authentication system according to a first embodiment of the present invention.

In the authentication system according to the first embodiment, a plurality of sub-terminals 72 to 74 are connected via coaxial cables under a main terminal 71. Coaxial TV cables already installed in a residence are used for the connection between the main terminal 71 and the sub-terminals 72 to 74, which are connected via a distributor 78 by coaxial cables 85 to 88. The sub-terminals 72 to 74 are respectively constituted by coaxial cable modems 79 to 81 and user terminals 82 to 84 such as PCs. The main terminal 71 is a master coaxial cable modem to be used together with client coaxial cable modems 79 to 81 when, for example, configuring a coaxial home network using coaxial cables installed for a TV in a residence.

While FIG. 1 shows a configuration in which three sub-terminals 72 to 74 are connected under the main terminal 71, the number of connected sub-terminals is not limited to this configuration. In addition, a plurality of main terminals 71 may exist in the authentication system according to the present first embodiment.

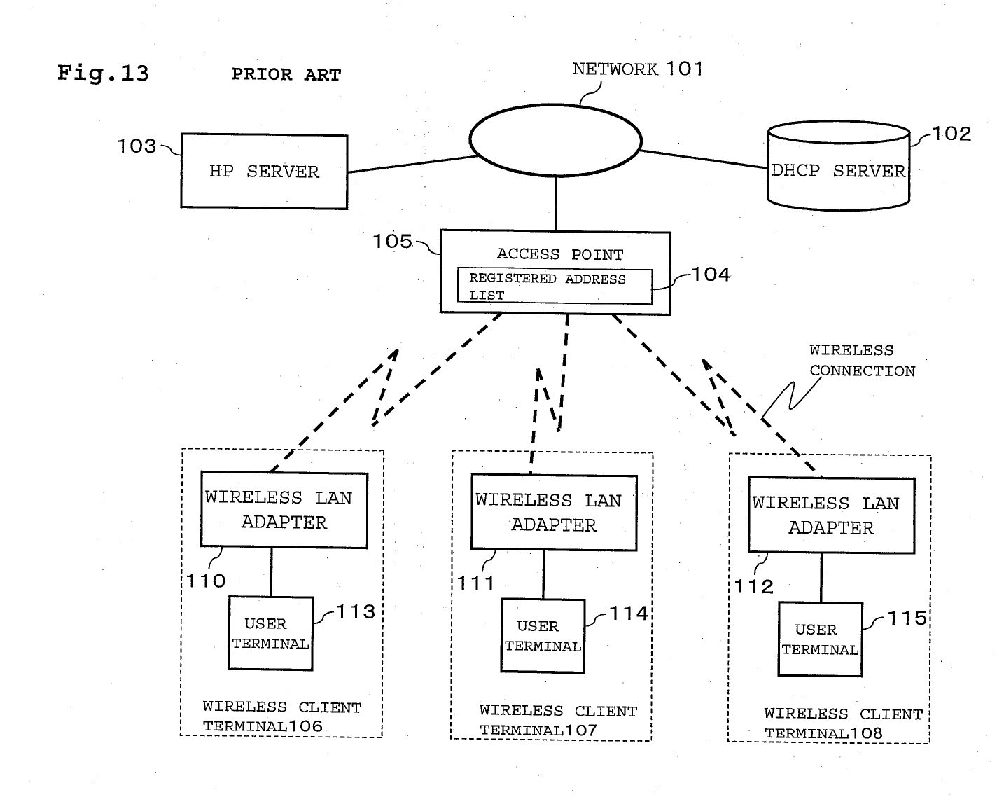

Connected above the main terminal 71 are an authentication server 75 that performs device authentication on the main terminal 71 and the sub-terminals 72 to 74, and a terminal management apparatus 76 that performs terminal management of the main terminal 71 and the sub-terminals 72 to 74. The authentication server 75 and the terminal management apparatus 76 respectively correspond to the DHCP server 102 and the HP server 103 in the conventional communication shown in FIG. 13. In addition, the main terminal 71, the authentication server 75 and the terminal management apparatus 76 are connected to the Internet 77 by an optical fiber cable 89.

Next, the respective configurations of the main terminal 71 and the coaxial cable modems 79 to 81 will be described.

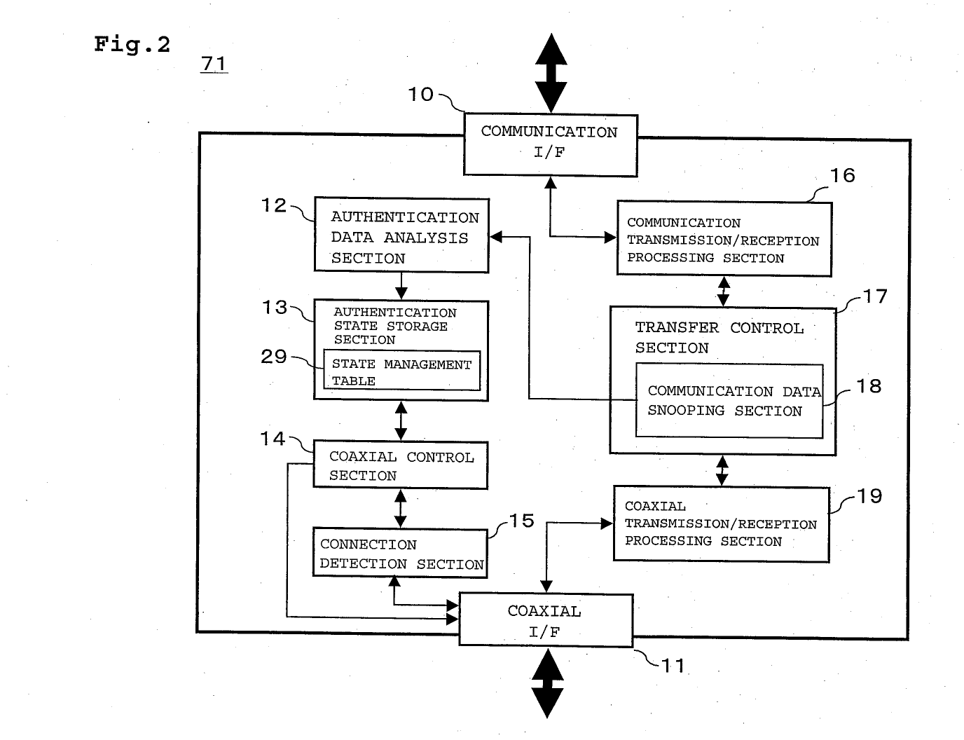

FIG. 2 shows an internal configuration diagram of the main terminal 71 shown in FIG. 1.

The main terminal 71 is provided with a communication I/F (interface) 10 and a coaxial I/F 11, and is a communication device that transfers data received from either I/F to a desired I/F. The communication I/F 10 is a communication I/F intended for, for example, Ethernet (registered trademark) which differs from the coaxial I/F. The main terminal 71 is also provided with a transfer control section 17 that controls processing on its own data or the like.

The main terminal 71 is further provided with a communication transmission/reception processing section 16 that processes data transmission/reception at the communication I/F 10, and a coaxial transmission/reception processing section 19 that processes data transmission/reception at the coaxial I/F 11. In addition, the transfer control section 17 includes a communication data snooping section 18 that snoopes data processed by the transfer control section 17. The main terminal 71 is also provided with: an authentication data analysis section 12 that, when data snooped by the communication data snooping section 18 is authentication data from the sub-terminals 72 to 74 connected under the main terminal 71 or from the authentication server 75, analyzes the authentication data; an authentication state storage section 13 that stores authentication states of the sub-terminals 72 to 74 connected under the main terminal 71 based on the analyzed authentication data; a coaxial control section 14 that controls coaxial connection of the sub-terminals 72 to 74 connected under the main terminal 71; and a connection detection section 15 that detects connections of the sub-terminals 72 to 74 connected to the coaxial I/F 11. The authentication state storage section 13 manages states of sub-terminals connected under the main terminal 71 using a state management table 29. In addition, the coaxial control section 14 is provided with a function for setting speeds to be used between the main terminal devices connected to the coaxial I/F 11.

The authentication state storage section 13, the coaxial control section 14, the connection detection section 15 and the state management table 29 are respectively examples of an authentication state control unit, a connection control unit, a connection detection unit and an authentication state table according to the present invention.

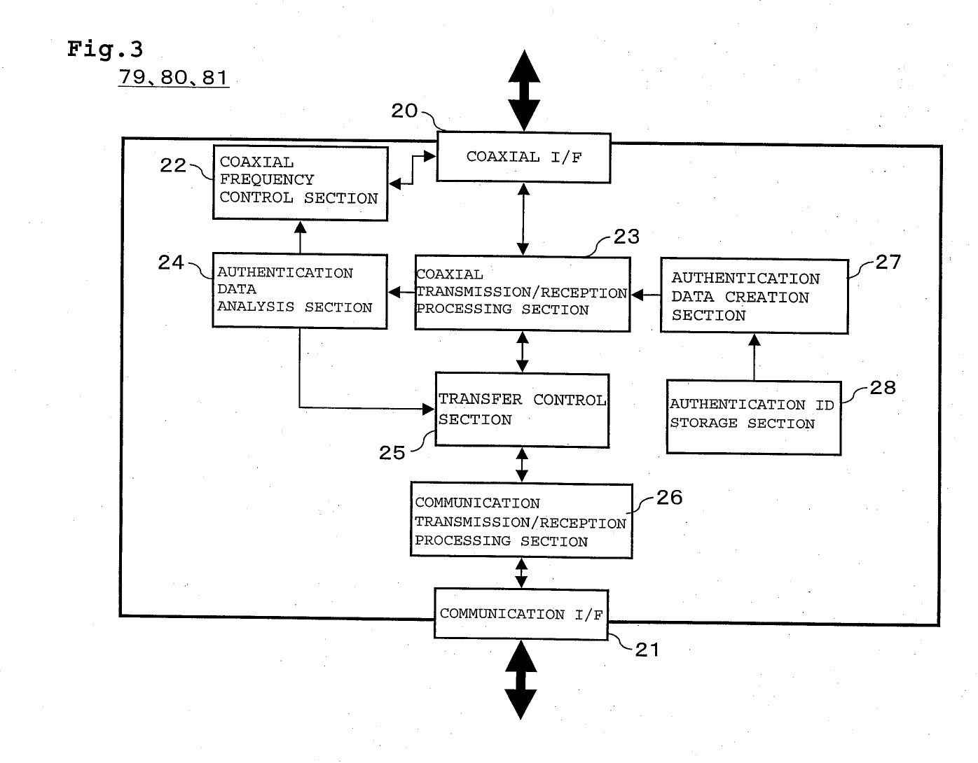

FIG. 3 shows an internal configuration diagram of the coaxial cable modems 79 to 81 constituting the sub-terminals 72 to 74 shown in FIG. 1.

The coaxial cable modems 79 to 81 are provided with a communication I/F 21 and a coaxial I/F 20, and are communication devices that transfer data received from either I/F to a desired I/F. The communication I/F 21 is a communication I/F intended for, for example, Ethernet which differs from the coaxial I/F. The coaxial cable modems 79 to 81 are also provided with a transfer control section 25 that controls processing of its own data.

The coaxial cable modems 79 to 81 are further provided with a communication transmission/reception processing section 26 that processes data transmission/reception at the communication I/F 21, and a coaxial transmission/reception processing section 23 that processes data transmission/reception at the coaxial I/F 20. The coaxial cable modems 79 to 81 are also provided with: an authentication ID storage section 28 that stores authentication IDs necessary when requesting device authentication of the coaxial cable modems 79 to 81 themselves: an authentication data creation section 27 that uses an authentication ID to create authentication request data; an authentication data analysis section 24 that analyzes authentication response data from the authentication server 75; and a coaxial frequency control section 22 that controls operating frequencies in coaxial connection.

Next, a management method by the main terminal 71 according to the present first embodiment of sub-terminals 72 to 74 connected thereunder will be described.

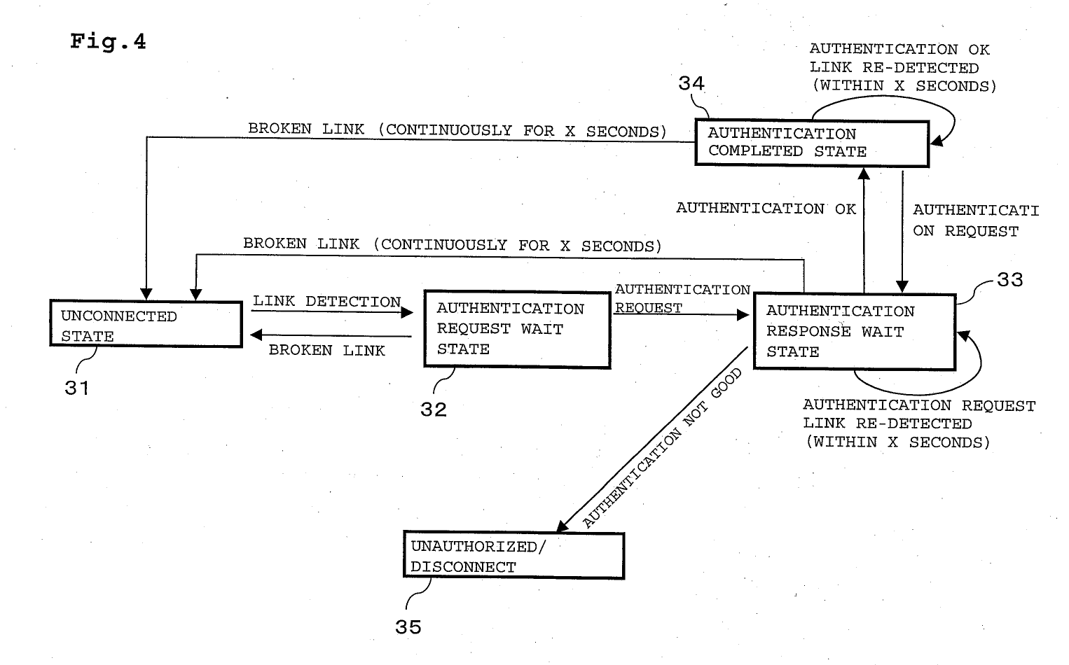

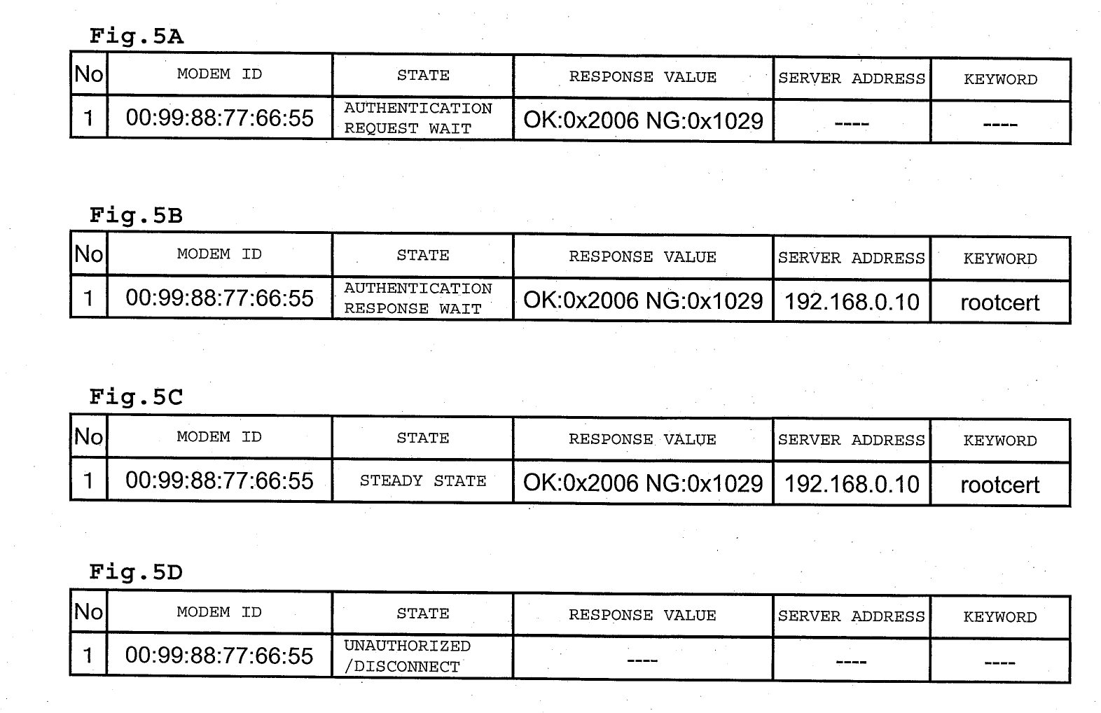

FIG. 4 shows a diagram showing state transitions upon authentication of sub-terminals 72 to 74 connected under and managed by the main terminal 71. FIGS. 5A to 5D show a state management table 29, which is managed by the main terminal 71 at the authentication state storage section 13, of the sub-terminal 72 connected under the main terminal 71.

A description will be given below which takes as an example a case where the sub-terminal 72 is newly connected to an operating frequency on which the main terminal 71 operates. In this case, the modem ID (here, a MAC address is assumed) of the coaxial cable modem 79 constituting the sub-terminal 72 is assumed to be (00:99:88:77:66:55).

First, operations of the main terminal 71 will be described.

When it is detected by the connection detection section 15 shown in FIG. 2 that the sub-terminal 72 is newly connected to the coaxial I/F 11, the main terminal 71 notifies the connection information to the authentication state storage section 13 via the coaxial control section 14. The authentication state storage section 13 registers the modem ID of the coaxial cable modem 79 in the state management table 29 as shown in FIG. 5A, and changes the transition state of the sub-terminal 72 to an “authentication request wait state” 32 as shown in FIG. 4.

The modem ID of the coaxial cable modem 79 that is registered in the state management table 29 at this point corresponds to an example of sub-terminal ID information.

Furthermore, the authentication state storage section 13 calculates the same data as authentication response data created by the authentication server 75 from the modem ID (00:99:88:77:66:55) and which indicates granted permission and denied permission respectively, and registers the authentication response data in “response value” of the state management table 29. In this case, it is assumed that the values of authentication response data indicating granted permission and denied permission are 0x2006 and 0x1029 respectively. Since a calculation method of these response values need only be shared among the authentication server 75, the main terminal 71 and the coaxial cable modem 79, a description thereof will not be given.

When the link connection of the coaxial cable modem 79 is disconnected in the “authentication request wait state” 32, the authentication state storage section 13 of the main terminal 71 deletes the sub-terminal 72 from the state management table 29. In other words, a transition is made to an “unconnected state” 31 shown in FIG. 4 which is a state where actual management is not provided.

Next, operations of the sub-terminal 72 connected to the main terminal 71 will be described.

At the coaxial cable modem 79 connected to the main terminal 71, in order to perform device authentication of itself, the authentication data creation section 27 acquires an authentication ID from the authentication ID storage section 28 and creates authentication request data. When the authentication data creation section 27 requests the coaxial transmission/reception processing section 23 to process the created authentication request data, the coaxial transmission/reception processing section 23 transmits the authentication request data to the authentication server 75 via the coaxial cable 85, the distributor 78, the coaxial cable 88 and the main terminal 71. The coaxial cable modem 79 continually re-transmits the authentication request data until authentication response data is received from the authentication server 75.

Next, operations of the main terminal 71 after transmission of authentication request data by the coaxial cable modem 79 will be described.

When the coaxial transmission/reception processing section 19 receives the authentication request data transmitted from the coaxial cable modem 79 via the coaxial I/F 11, the main terminal 71 passes the authentication request data onto the transfer control section 17. The communication data snooping section 18 of the transfer control section 17 snoopes the communication data (in this case, authentication request data) and passes the communication data onto the authentication data analysis section 12. Then, the authentication request data is transferred without modification by the communication transmission/reception processing section 16 to the communication I/F 10.

The authentication data analysis section 12 determines whether the communication data passed from the communication data snooping section 18 is authentication data. In this case, authentication data refers to either authentication request data or authentication response data. If the communication data is not authentication data, no action is taken. If the communication data is authentication data, further determination is made on whether the authentication data is authentication request data or authentication response data.

In the case of authentication request data from the newly connected coaxial cable modem 79, the authentication state storage section 13 causes a transition of the state of the sub-terminal 72 in the state management table 29 to be made to an “authentication response wait state” 33 as shown in FIG. 5B.

The authentication state storage section 13 further extracts the address of the authentication server 75 and a keyword for authentication response data from the authentication request data received from the coaxial cable modem 79, and simultaneously registers the address and the keyword in the state management table 29. In this configuration, the address of the authentication server 75 is assumed to be “192.168.0.10”, while the keyword for authentication response data is assumed to be “rootcert”.

When the link connection of the coaxial cable modem 79 is continuously disconnected for X seconds in the “authentication response wait state” 33, the authentication state storage section 13 of the main terminal 71 deletes the sub-terminal 72 from the state management table 29. In other words, a transition is made to the “unconnected state” 31 shown in FIG. 4 which is a state where actual management is not provided.

Meanwhile, when the link connection of the coaxial cable modem 79 is disconnected in the “authentication response wait state” 33 only to be reconnected within a certain amount of time (X seconds), the authentication state storage section 13 of the main terminal 71 maintains the “authentication response wait state” 33 in the state management table 29. It is needless to say that the certain amount of time (X seconds) can take any value that is optimal to the system.

Next, operations of the authentication server 75 will be described.

Upon reception of authentication request data from the coaxial cable modem 79 transferred by the main terminal 71, if the authentication ID included in the authentication request data from the coaxial cable modem 79 is correct, the authentication server 75 calculates authentication response data for granted authentication permission based on the modem ID and transmits the authentication response data to the sub-terminal 72. If the authentication ID is not correct, the authentication server 75 calculates authentication response data for denied authentication permission and transmits the authentication response data to the sub-terminal 72.

The authentication response data indicating granted authentication permission and denied authentication permission calculated at this point by the authentication server 75 is the same as the data calculated when receiving the authentication request data from the coaxial cable modem 79 and stored in the state management table 29 shown in FIG. 5A by the authentication state storage section 13 of the main terminal 71.

Next, operations of the main terminal 71 after transmission of the authentication response data by the authentication server 75 will be described.

When the communication transmission/reception processing section 16 receives the authentication response data transmitted from the authentication server 75 via the communication I/F 10, the main terminal 71 passes the authentication response data onto the transfer control section 17. The communication data snooping section 18 of the transfer control section 17 snoopes the communication data (in this case, authentication response data) and passes the communication data onto the authentication data analysis section 12. Then, the authentication response data is transferred without modification by the coaxial transmission/reception processing section 19 to the coaxial I/F 11.

The authentication data analysis section 12 determines whether the communication data passed from the communication data snooping section 18 is authentication data. If the communication data is not authentication data, no action is taken. If the communication data is authentication data, determination is made on whether the authentication data is authentication request data or authentication response data.

In the case of authentication response data, the authentication state storage section 13 determines which sub-terminal the authentication response data is addressed to. In the case where the authentication response data is for the sub-terminal 72 managed by the state management table 29, the authentication state storage section 13 compares a transmission source address, an authentication data keyword and a response value included in the authentication response data respectively with the address of the authentication server 75, the keyword and the response value registered in the state management table 29 shown in FIG. 5B.

When even one does not match, no action is taken. When all match and the response value is “permission granted”, the authentication state storage section 13 causes a transition of the state of the state management table 29 of the sub-terminal 72 to be made to a “steady state (authentication completed state)” 34 shown in FIG. 5C.

Meanwhile, when all match and the response value is “permission denied”, the authentication state storage section 13 causes a transition of the state of the state management table 29 of the sub-terminal 72 to be made to “unauthorized/disconnect” 35 as shown in FIG. 5D, and disconnects the connection with the target coaxial cable modem 79 at the physical layer using the coaxial control section 14.

Next, operations of the coaxial cable modem 79 after the main terminal 71 transfers authentication response data from the authentication server 75 will be described.

When the coaxial transmission/reception processing section 23 receives the authentication response data transmitted from the authentication server 75 which was transferred by the main terminal 71 via the coaxial I/F 20, the coaxial cable modem 79 passes the authentication response data onto the authentication data analysis section 24.

When the response value of the authentication response data is “permission granted”, the authentication data analysis section 24 instructs the transfer control section 25 to commence transfer and commences communication data transfer, whereby communication by the user terminal 82 connected to the coaxial cable modem 79 is enabled. When the response value of the authentication response data is “permission denied”, no action is taken. In other words, in this case, permission for communication data transfer remains denied.

Next, a management method by the main terminal 71 of the state of the sub-terminal 72 after transition to the “steady state (authentication completed state)” 34 will be described.

When the link connection of the coaxial cable modem 79 is continuously disconnected for X seconds in the “authentication completed state” 34, the authentication state storage section 13 of the main terminal 71 deletes the sub-terminal 72 from the state management table 29. In other words, the state is changed to the “unconnected state” 31 shown in FIG. 4 which is a state where actual management is not provided.

Meanwhile, when the link connection of the coaxial cable modem 79 is disconnected in the “authentication completed state” 34 only to be reconnected within a certain amount of time (X seconds), the authentication state storage section 13 of the main terminal 71 maintains the “authentication completed state” 34 in the state management table 29. It is needless to say that the certain amount of time (X seconds) can take any value that is optimal to the system.

The present first embodiment described above has been arranged so that it is detected by the connection detection section 15 of the main terminal 71 that the sub-terminal 72 has been newly connected to the coaxial I/F 11, and when causing a transition of the transitional state of the sub-terminal 72 from the “unconnected state” 31 to the “authentication request wait state” 32, the authentication state storage section 13 calculates authentication response data respectively indicating granted permission and denied permission which is created by the authentication server 75 for the sub-terminal 72, and registers the authentication response data in “response value” of the state management table 29. However, instead of calculating the authentication response data at this point, the calculation may be performed upon receiving authentication response data intended for the sub-terminal 72 from the authentication server 75 in the “authentication response wait state” 33, whereby the calculated values are compared with response values included in the authentication response data received at that point.

With the authentication system according to the present first embodiment described above, link establishment by a sub-terminal is blocked once the main terminal 71 determines that the sub-terminal is unauthorized and causes a transition to be made to the “unauthorized/disconnect” state. Therefore, since there is no longer a risk that a sub-terminal once denied permission transmits an authentication request to the authentication server 75, it is now possible to significantly reduce the load on the authentication server 75.

In addition, with the conventional communication system shown in FIG. 13, reducing the load of authentication on the DHCP server 102 required that MAC addresses of authorized client terminals were registered in advance in the registered address list 104. Since this method required updating the registered address list 104 in the access point 105, for example, every time a wireless client terminal under the DHCP server 102 is added, management becomes cumbersome.

With the authentication system according to the present first embodiment, by having the main terminal 71 snoope authentication data from the sub-terminals 72 to 74 and from the authentication server 75 to manage authentication states, in the case of an unauthorized sub-terminal, the main terminal 71 automatically registers the sub-terminal as an unauthorized terminal. This eliminates the need for registering authorized terminals or the like in advance, and management can be simplified as compared to conventional communication systems such as that shown in FIG. 13.

Moreover, in a case where an unauthorized spoofing authentication server instead of the authorized authentication server 75 attempts to authenticate the sub-terminal 72, it is conceivable that the spoofing authentication server will not transmit a correct keyword and response value which would otherwise be transmitted from the authorized authentication server 75. With the authentication system according to the present first embodiment, it is now possible to prevent responses from a spoofing authentication server by comparing an address of the authentication server 75, a keyword and a system-unique response value, and a more robust system can be established. With the authentication system according to the present first embodiment, when a keyword or a response value included in authentication response data does not have the correct value, both the main terminal 71 and the sub-terminal 72 determine that the authentication response data is not from the authorized authentication server 75 and ignore the authentication response data.

### Second Embodiment

Next, a management method by a main terminal of sub-terminals connected thereunder in an authentication system according to a second embodiment of the present invention will be described.

The configuration of the authentication system as well as the configurations of the main terminal 71 and the sub-terminals 72 to 74 according to the present second embodiment are the same as those in the first embodiment, and are as illustrated in FIG. 1.

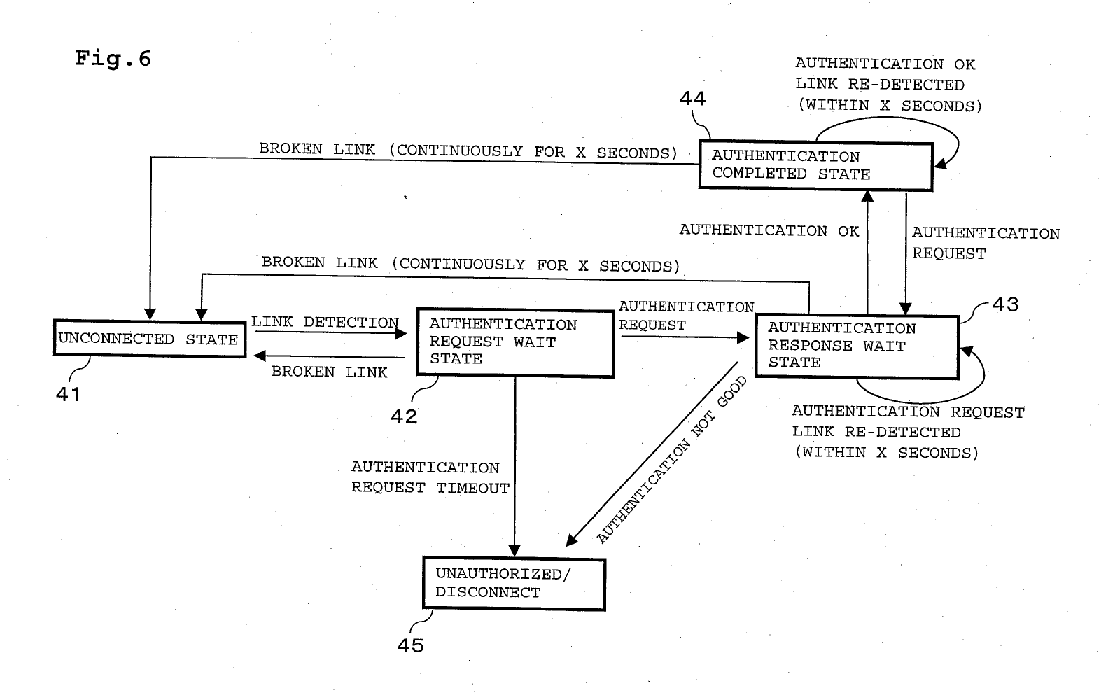

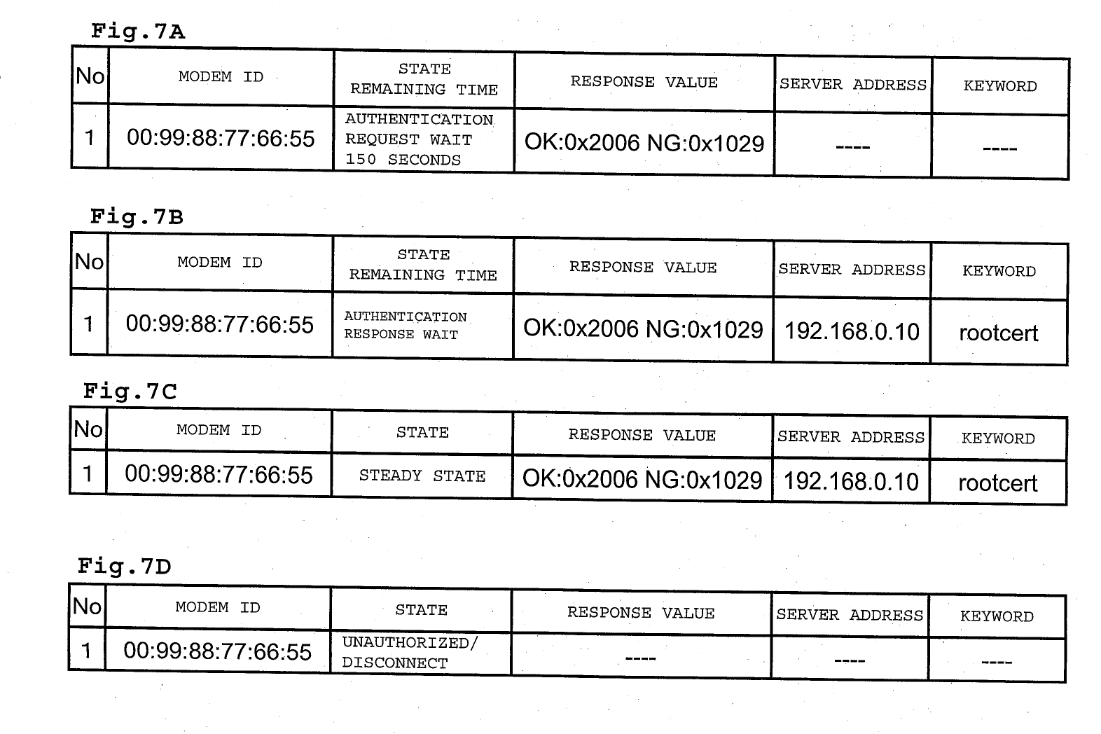

FIG. 6 shows a diagram showing state transitions upon authentication of sub-terminals 72 to 74 connected under and managed by the main terminal 71. FIGS. 7A to 7D show state management tables 29, which are managed by the main terminal 71 at the authentication state storage section 13, of the sub-terminals 72 to 74 connected under the main terminal 71.

A description will be given below which takes as an example a case where the sub-terminal 72 is newly connected to an operating frequency on which the main terminal 71 operates. In this case, the modem ID (here, a MAC address is assumed) of the coaxial cable modem 79 constituting the sub-terminal 72 is assumed to be (00:99:88:77:66:55).

First, operations of the main terminal 71 will be described.

When it is detected by the connection detection section 15 shown in FIG. 2 that the sub-terminal 72 is newly connected to the coaxial I/F 11, the main terminal 71 notifies the connection information to the authentication state storage section 13 via the coaxial control section 14. The authentication state storage section 13 registers the modem ID of the coaxial cable modem 79 in the state management table 29 as shown in FIG. 7A, and changes the transition state of the sub-terminal 72 to an “authentication request wait state” 42 as shown in FIG. 6.

Furthermore, the authentication state storage section 13 calculates the same data as authentication response data created by the authentication server 75 from the modem ID (00:99:88:77:66:55) and which indicates granted permission and denied permission respectively, and registers the authentication response data in “response value” of the state management table 29. In this case, it is assumed that the values of authentication response data indicating granted permission and denied permission are 0x2006 and 0x1029 respectively. Since a calculation method of these response values need only be shared among the authentication server 75, the main terminal 71 and the coaxial cable modem 79, a description thereof will not be given.

Further, the main terminal 71 also registers a maximum authentication request timeout time (150 seconds), during which it is assumed that the coaxial cable modem 79 newly connected thereunder will transmit authentication request data, to the state management table 29 as shown in FIG. 7A. The authentication request timeout time registered in the state management table 29 is counted down, and reset to 150 seconds every time the coaxial cable modem 79 connected under the main terminal 71 retransmits authentication request data. While the maximum authentication request timeout time is set to 150 seconds in this configuration, it is needless to say that this value should represent an optimum time in accordance with the system. The authentication request timeout time corresponds to the authentication request timeout period according to the present invention.

When the authentication state storage section 13 of the main terminal 71 does not receive authentication request data from the newly connected coaxial cable modem 79 within the maximum authentication request timeout time (150 seconds), the authentication state storage section 13 of the main terminal 71 determines that the sub-terminal 72 is an unauthorized terminal that does not conform to the normal authentication sequence, causes a transition of the state of the state management table 29 of the sub-terminal 72 to be made to “unauthorized/disconnect” 45 as shown in FIG. 7D, and disconnects the connection with the target coaxial cable modem 79 at the physical layer using the coaxial control section 14.

In the “authentication request wait state” 42, when the link connection of the coaxial cable modem 79 is disconnected within the maximum authentication request timeout time (150 seconds), the authentication state storage section 13 deletes the sub-terminal 72 from the state management table 29. In other words, a transition is made to an “unconnected state” 41 shown in FIG. 6 which is a state where actual management is not provided.

Next, operations of the sub-terminal 72 connected to the main terminal 71 will be described.

At the coaxial cable modem 79 connected to the main terminal 71, in order to perform device authentication of itself, the authentication data creation section 27 acquires an authentication ID from the authentication ID storage section 28 and creates authentication request data. When the authentication data creation section 27 requests the coaxial transmission/reception processing section 23 to process the created authentication request data, the coaxial transmission/reception processing section 23 transmits the authentication request data to the authentication server 75 via the coaxial cable 85, the distributor 78, the coaxial cable 88 and the main terminal 71. The coaxial cable modem 79 continually re-transmits the authentication request data until authentication response data is received from the authentication server 75.

Next, operations of the main terminal 71 after transmission of authentication request data by the coaxial cable modem 79 will be described.

When the coaxial transmission/reception processing section 19 receives the authentication request data transmitted from the coaxial cable modem 79 via the coaxial I/F 11, the main terminal 71 passes the authentication request data onto the transfer control section 17. The communication data snooping section 18 of the transfer control section 17 snoopes the communication data (in this case, authentication request data) and passes the communication data onto the authentication data analysis section 12. Then, the authentication request data is transferred without modification by the communication transmission/reception processing section 16 to the communication I/F 10.

The authentication data analysis section 12 determines whether the communication data passed from the communication data snooping section 18 is authentication data. If the communication data is not authentication data, no action is taken. If the communication data is authentication data, determination is made on whether the authentication data is authentication request data or authentication response data.

In the case of authentication request data from the newly connected coaxial cable modem 79, the authentication state storage section 13 causes a transition of the state of the sub-terminal 72 in the state management table 29 to be made to an “authentication response wait state” 43 as shown in FIG. 7B.

The authentication state storage section 13 further extracts the address of the authentication server 75 and a keyword for authentication response data from the authentication request data received from the coaxial cable modem 79, and simultaneously registers the address and the keyword in the state management table 29. In this configuration, the address of the authentication server 75 is assumed to be “1192.168.0.10”, while the keyword for authentication response data is assumed to be “rootcert”.

When the link connection of the coaxial cable modem 79 is continuously disconnected for X seconds in the “authentication response wait state” 43, the authentication state storage section 13 of the main terminal 71 deletes the sub-terminal 72 from the state management table 29. In other words, a transition is made to the “unconnected state” 41 shown in FIG. 6 which is a state where actual management is not provided.

Meanwhile, when the link connection of the coaxial cable modem 79 is disconnected in the “authentication response wait state” 43 only to be reconnected within a certain amount of time (X seconds), the authentication state storage section 13 of the main terminal 71 maintains the “authentication response wait state” 43 in the state management table 29. It is needless to say that the certain amount of time (X seconds) can take any value that is optimal to the system.

Next, operations of the authentication server 75 will be described.

Upon reception of authentication request data from the coaxial cable modem 79 transferred by the main terminal 71, if the authentication ID included in the authentication request data from the coaxial cable modem 79 is correct, the authentication server 75 calculates authentication response data for granted authentication permission based on the modem ID and transmits the authentication response data to the sub-terminal 72. If the authentication ID is not correct, the authentication server 75 calculates authentication response data for denied authentication permission and transmits the authentication response data to the sub-terminal 72.

The authentication response data indicating granted authentication permission and denied authentication permission calculated at this point by the authentication server 75 is the same as the data calculated when receiving the authentication request data from the coaxial cable modem 79 and stored in the state management table 29 shown in FIG. 7A by the authentication state storage section 13 of the main terminal 71.

Next, operations of the main terminal 71 after transmission of the authentication response data by the authentication server 75 will be described.

When the communication transmission/reception processing section 16 receives the authentication response data transmitted from the authentication server 75 via the communication I/F 10, the main terminal 71 passes the authentication response data onto the transfer control section 17. The communication data snooping section 18 of the transfer control section 17 snoopes the communication data (in this case, authentication response data) and passes the communication data onto the authentication data analysis section 12. Then, the authentication response data is transferred without modification by the coaxial transmission/reception processing section 19 to the coaxial I/F 11.

The authentication data analysis section 12 determines whether the communication data passed from the communication data snooping section 18 is authentication data. If the communication data is not authentication data, no action is taken. If the communication data is authentication data, determination is made on whether the authentication data is authentication request data or authentication response data.

In the case of authentication response data, the authentication state storage section 13 determines which sub-terminal the authentication response data is addressed to. In the case where the authentication response data is for the sub-terminal 72 managed by the state management table 29, the authentication state storage section 13 compares a transmission source address, an authentication data keyword and a response value included in the authentication response data respectively with the address of the authentication server 75, the keyword and the response value registered in the state management table 29 shown in FIG. 7B.

When even one does not match, no action is taken. When all match and the response value is “permission granted”, the authentication state storage section 13 causes a transition of the state of the state management table 29 of the sub-terminal 72 to be made to a “steady state (authentication completed state)” 44 shown in FIG. 7C. Meanwhile, when all match and the response value is “permission denied”, the authentication state storage section 13 causes a transition of the state of the state management table 29 of the sub-terminal 72 to be made to “unauthorized/disconnect” 45 as shown in FIG. 7D, and disconnects the connection with the target coaxial cable modem 79 at the physical layer using the coaxial control section 14.

Next, operations of the coaxial cable modem 79 after the main terminal 71 transfers authentication response data from the authentication server 75 will be described.

When the coaxial transmission/reception processing section 23 receives the authentication response data from the authentication server 75 which was transferred by the main terminal 71 via the coaxial I/F 20, the coaxial cable modem 79 passes the authentication response data onto the authentication data analysis section 24.

When the response value of the authentication response data is “permission granted”, the authentication data analysis section 24 instructs the transfer control section 25 to commence transfer and commences communication data transfer, whereby communication by the user terminal 82 connected to the coaxial cable modem 79 is enabled. When the response value of the authentication response data is “permission denied”, no action is taken. In other words, in this case, permission for communication data transfer remains denied.

Next, a management method by the main terminal 71 of the state of the sub-terminal 72 after transition to the “steady state (authentication completed state)” 44 will be described.

When the link connection of the coaxial cable modem 79 is continuously disconnected for X seconds in the “authentication completed state” 44, the authentication state storage section 13 of the main terminal 71 deletes the sub-terminal 72 from the state management table 29. In other words, a transition is made to the “unconnected state” 41 shown in FIG. 6 which is a state where actual management is not provided.

Meanwhile, when the link connection of the coaxial cable modem 79 is disconnected in the “authentication completed state” 44 only to be reconnected within a certain amount of time (X seconds), the authentication state storage section 13 of the main terminal 71 maintains the “authentication completed state” 44 in the state management table 29. It is needless to say that the certain amount of time (X seconds) can take any value that is optimal to the system.

With the authentication system according to the present second embodiment described above, in the same manner as with the first embodiment, link establishment by a sub-terminal becomes completely impossible once the main terminal 71 determines that the sub-terminal is unauthorized and causes a transition to be made to the “unauthorized/disconnect” state. Therefore, since there is no longer a risk that a sub-terminal once denied permission transmits an authentication request to the authentication server 75, it is now possible to significantly reduce the load on the authentication server 75.

In addition, with the authentication system according to the present second embodiment, by having the main terminal 71 snoope authentication data from the sub-terminals 72 to 74 thereunder and from the authentication server 75 to manage authentication states, the main terminal 71 automatically registers unauthorized terminals even when a sub-terminal is unauthorized or when a pirate sub-terminal, such as a sub-terminal that sidesteps normal authentication sequences by avoiding authentication or the like, is connected. This eliminates the need for registering authorized terminals or the like in advance, and simplification of management can be achieved.

Moreover, by comparing an address of the authentication server 75, a keyword and a system-unique response value, it is now possible to prevent responses from a spoofing authentication server, and a more robust system can be established.

### Third Embodiment

Next, a management method by a main terminal of sub-terminals connected thereunder in an authentication system according to a third embodiment of the present invention will be described.

The configuration of the authentication system as well as the configurations of the main terminal 71 and the sub-terminals 72 to 74 according to the present third embodiment are the same as those in the first embodiment, and are as illustrated in FIG. 1.

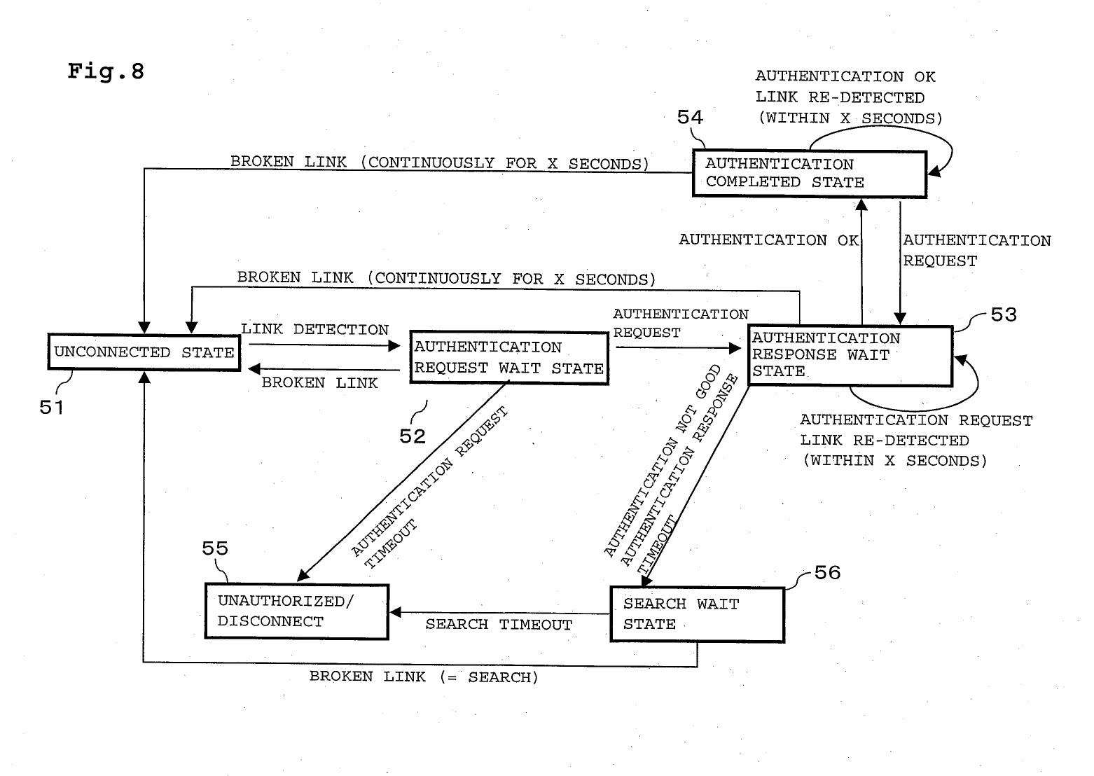

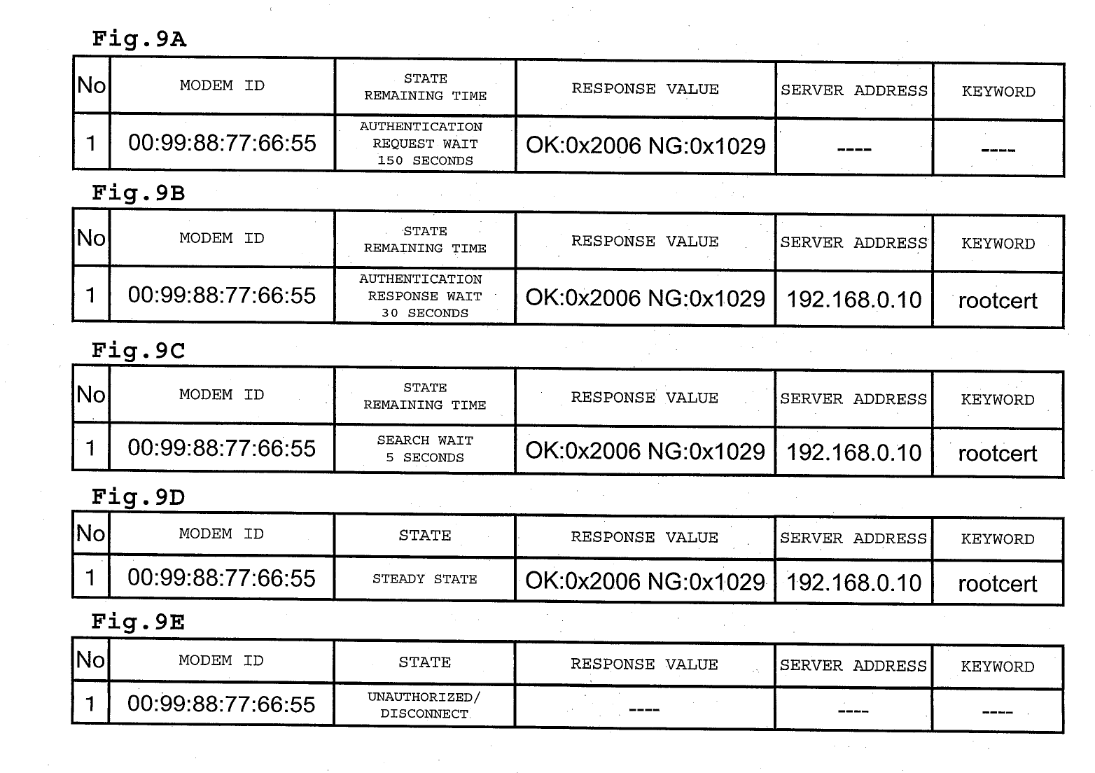

FIG. 8 shows a diagram showing state transitions upon authentication of sub-terminals 72 to 74 connected under and managed by the main terminal 71. FIGS. 9A to 9E show state management tables 29, which are managed by the main terminal 71 at the authentication state storage section 13, of the sub-terminals 72 to 74 connected under the main terminal 71.

A description will be given below which takes as an example a case where the sub-terminal 72 is newly connected to an operating frequency on which the main terminal 71 operates. In this case, the modem ID (here, a MAC address is assumed) of the coaxial cable modem 79 constituting the sub-terminal 72 is assumed to be (00:99:88:77:66:55).

First, operations of the main terminal 71 will be described.

When it is detected by the connection detection section 15 shown in FIG. 2 that the sub-terminal 72 is newly connected to the coaxial I/F 11, the main terminal 71 notifies the connection information to the authentication state storage section 13 via the coaxial control section 14. The authentication state storage section 13 registers the modem ID of the coaxial cable modem 79 in the state management table 29 as shown in FIG. 9A, and changes the transition state of the sub-terminal 72 to an “authentication request wait state” 52 as shown in FIG. 8.

Furthermore, the authentication state storage section 13 calculates the same data as authentication response data created by the authentication server 75 from the modem ID (00:99:88:77:66:55) and which indicates granted permission and denied permission respectively, and registers the authentication response data in “response value” of the state management table 29. In this case, it is assumed that the values of authentication response data indicating granted permission and denied permission are 0x2006 and 0x1029 respectively. Since a calculation method of these response values need only be shared among the authentication server 75, the main terminal 71 and the coaxial cable modem 79, a description thereof will not be given.

Further, the authentication state storage section 13 also registers a maximum authentication request timeout time (150 seconds), during which it is assumed that the coaxial cable modem 79 newly connected under the main terminal 71 will transmit authentication request data, to the state management table 29 as shown in FIG. 9A. The authentication request timeout time registered in the state management table 29 is counted down, and reset to 150 seconds every time the coaxial cable modem 79 connected under the main terminal 71 retransmits authentication request data. While the maximum authentication request timeout time is set to 150 seconds in this configuration, it is needless to say that this value should represent an optimum time in accordance with the system.

When the authentication state storage section 13 of the main terminal 71 does not receive authentication request data from the newly connected coaxial cable modem 79 within the maximum authentication request timeout time (150 seconds), the authentication state storage section 13 of the main terminal 71 determines that the sub-terminal 72 is an unauthorized terminal that does not conform to the normal authentication sequence, causes a transition of the state of the state management table 29 of the sub-terminal 72 to be made to “unauthorized/disconnect” 55 as shown in FIG. 9E, and disconnects the connection with the target coaxial cable modem 79 at the physical layer using the coaxial control section 14.

In the “authentication request wait state” 52, when the link connection of the coaxial cable modem 79 is disconnected within the maximum authentication request timeout time (150 seconds), the authentication state storage section 13 deletes the sub-terminal 72 from the state management table 29. In other words, a transition is made to an “unconnected state” 51 shown in FIG. 8 which is a state where actual management is not provided.

Next, operations of the sub-terminal 72 connected to the main terminal 71 will be described.

With the coaxial cable modem 79 connected to the main terminal 71, in order to perform device authentication of itself, the authentication data creation section 27 acquires an authentication ID from the authentication ID storage section 28 and creates authentication request data. When the authentication data creation section 27 requests the coaxial transmission/reception processing section 23 to process the created authentication request data, the coaxial transmission/reception processing section 23 transmits the authentication request data to the authentication server 75 via the coaxial cable 85, the distributor 78, the coaxial cable 88 and the main terminal 71.

When the coaxial transmission/reception processing section 23 does not receive authentication response data from the authentication server 75 within a prescribed time (e.g., 5 seconds), the transfer control section 25 of the coaxial cable modem 79 causes the coaxial transmission/reception processing section 23 to retransmit the authentication request data to the authentication server 75. Furthermore, when the number of retransmissions of authentication response data exceeds a prescribed number of times (e.g., five times), the transfer control section 25 causes the coaxial frequency control section 22 to perform a frequency search to attempt connection under another main terminal using an operating frequency that differs from the operating frequency used by the main terminal 71.

The coaxial frequency control section 22 corresponds to an example of the frequency control unit according to the present invention.

Next, operations of the main terminal 71 after transmission of authentication request data by the coaxial cable modem 79 will be described.

When the coaxial transmission/reception processing section 19 receives the authentication request data transmitted from the coaxial cable modem 79 via the coaxial I/F 11, the main terminal 71 passes the authentication request data onto the transfer control section 17. The communication data snooping section 18 of the transfer control section 17 snoopes the communication data (in this case, authentication request data) and passes the communication data onto the authentication data analysis section 12. Then, the authentication request data is transferred without modification by the communication transmission/reception processing section 16 to the communication I/F 10.

The authentication data analysis section 12 determines whether the communication data passed from the communication data snooping section 18 is authentication data. If the communication data is not authentication data, no action is taken. If the communication data is authentication data, determination is made on whether the authentication data is authentication request data or authentication response data.

In the case of authentication request data from the newly connected coaxial cable modem 79, the authentication state storage section 13 causes a transition of the state of the sub-terminal 72 in the state management table 29 to be made to an “authentication response wait state” 53 as shown in FIG. 9B.

Further, when authentication response data does not arrive from the authentication server 75 after transmission of the authentication request data from the coaxial cable modem 79 newly connected under the main terminal 71, the authentication state storage section 13 registers a time (authentication response timeout: 5 seconds×retransmission: 5 times+margin=30 seconds) during which authentication response timeout is expected by the coaxial cable modem 79 as shown in FIG. 9B. While the authentication response timeout time is set to 30 seconds in this case, it is needless to say that the authentication response timeout time can take any value that is optimal to the system.

The authentication response timeout time corresponds to the authentication response timeout period according to the present invention.

When the link connection of the coaxial cable modem 79 is continuously disconnected for X seconds in the “authentication response wait state” 53, the authentication state storage section 13 of the main terminal 71 deletes the sub-terminal 72 from the state management table 29. In other words, a transition is made to the “unconnected state” 51 shown in FIG. 8 which is a state where actual management is not provided.

Meanwhile, when the link connection of the coaxial cable modem 79 is disconnected in the “authentication response wait state” 53 only to be reconnected within a certain amount of time (X seconds), the authentication state storage section 13 of the main terminal 71 maintains the “authentication response wait state” 53 in the state management table 29. It is needless to say that the certain amount of time (X seconds) can take any value that is optimal to the system.

Next, operations of the authentication server 75 will be described.

Upon reception of authentication request data from the coaxial cable modem 79 transferred by the main terminal 71, if the authentication ID included in the authentication request data from the coaxial cable modem 79 is correct, the authentication server 75 calculates authentication response data for granted authentication permission based on the modem ID and transmits the authentication response data to the sub-terminal 72. If the authentication ID is not correct, the authentication server 75 calculates authentication response data for denied authentication permission and transmits the authentication response data to the sub-terminal 72.

The authentication response data indicating granted authentication permission and denied authentication permission calculated at this point by the authentication server 75 is the same as the data calculated when receiving the authentication request data from the coaxial cable modem 79 and stored in the state management table 29 shown in FIG. 9A by the authentication state storage section 13 of the main terminal 71.

Next, operations of the main terminal 71 after transmission of the authentication response data by the authentication server 75 will be described.

When the communication transmission/reception processing section 16 receives the authentication response data transmitted from the authentication server 75 via the communication I/F 10, the main terminal 71 passes the authentication response data onto the transfer control section 17. The communication data snooping section 18 of the transfer control section 17 snoopes the communication data (in this case, authentication response data) and passes the communication data onto the authentication data analysis section 12. Then, the authentication response data is transferred without modification by the coaxial transmission/reception processing section 19 to the coaxial I/F 11.

The authentication data analysis section 12 determines whether the communication data passed from the communication data snooping section 18 is authentication data. If the communication data is not authentication data, no action is taken. If the communication data is authentication data, determination is made on whether the authentication data is authentication request data or authentication response data.

In the case of authentication response data, the authentication state storage section 13 determines which sub-terminal the authentication response data is addressed to. In the case where the authentication response data is for the sub-terminal 72 managed by the state management table 29, the authentication state storage section 13 compares a transmission source address, an authentication data keyword and a response value included in the authentication response data respectively with the address of the authentication server 75, the keyword and the response value registered in the state management table 29 shown in FIG. 9B.

When even one does not match, no action is taken. When all match and the response value is “permission granted”, the authentication state storage section 13 causes a transition of the state of the state management table 29 of the sub-terminal 72 to be made to a “steady state (authentication completed state)” 54 shown in FIG. 9D.

When all match and the response value is “permission denied”, the authentication state storage section 13 causes a transition of the state of the state management table 29 of the sub-terminal 72 to be made to a “search wait state” 56 as shown in FIG. 9C. At the same time, a search timeout time (in this case, 5 seconds) during which, after reception of a “permission denied” authentication response data, a sub-terminal, if authorized, should at least perform a frequency search, is also set in the state management table 29.

The search timeout time in this case corresponds to the denied permission reception timeout period according to the present invention.

Moreover, in the event that authentication response data does not arrive from the authentication server 75 even when the period (in this case, set to 30 seconds), set in the state management table 29 upon transition to the “authentication response wait state” 53, during which an authentication response timeout is expected by the coaxial cable modem 79, the authentication state storage section 13 determines that an authentication response timeout has occurred at the sub-terminal 72 and causes a transition of the state of the state management table 29 to be made to a “search wait state (56)” as shown in FIG. 9C. At the same time, a search timeout time (in this case, 5 seconds) during which, after authentication response timeout, a sub-terminal, if authorized, should at least perform a frequency search, is also set in the state management table 29.

While the search timeout time is set to 5 seconds in this case, it is needless to say that the search timeout time can take any value that is optimal to the system.

The authentication state storage section 13 determines sub-terminals continuously connecting to the main terminal 71 for the duration of the search timeout time (5 seconds) or more without performing frequency searches upon reception of authentication response data having an authentication result of “permission denied”, as well as sub-terminals continuously connecting to the main terminal 71 for the duration of the search timeout time (5 seconds) or more without performing frequency searches upon expiration of the authentication response timeout time (30 seconds) without the arrival of authentication response data, to be unauthorized terminals that do not conform to the normal authentication sequence, causes a transition of the state of the state management table 29 of the sub-terminals to be made to “unauthorized/disconnect” 55 as shown in FIG. 9E, and disconnects the connections with the target sub-terminals at the physical layer using the coaxial control section 14.

When a sub-terminal in the “search wait state (56)” performs a frequency search within the search timeout time (5 seconds) and the link is disconnected, the authentication state storage section 13 determines the sub-terminal to be an authorized terminal, and deletes the sub-terminal from the state management table 29. In other words, the state is changed to the “unconnected state” 51 shown in FIG. 8 which is a state where actual management is not provided.

As seen, by using a search timeout time, sub-terminals that fail to disconnect the link through the authorized sequence can now be treated as unauthorized terminals, and in a case where an improper connection is attempted by an authorized sub-terminal belonging to another main terminal using a different frequency, handling of the sub-terminal can now be avoided by considering the sub-terminal to be an unauthorized terminal.

Next, operations of the coaxial cable modem 79 after the main terminal 71 transfers authentication response data from the authentication server 75 will be described.

When the coaxial transmission/reception processing section 23 receives the authentication response data from the authentication server 75 which was transferred by the main terminal 71 via the coaxial I/F 20, the coaxial cable modem 79 passes the authentication response data onto the authentication data analysis section 24.

When the response value of the authentication response data is “permission granted”, the authentication data analysis section 24 instructs the transfer control section 25 to commence transfer and commences communication data transfer, whereby communication by the user terminal 82 connected to the coaxial cable modem 79 is enabled. When the response value of the authentication response data is “permission denied”, the coaxial frequency control section 22 performs a frequency search and proceeds to connect under another main terminal using an operating frequency that differs from the operating frequency used by the main terminal 71.

Next, a management method by the main terminal 71 of the state of the sub-terminal 72 after transition to the “steady state (authentication completed state)” 54 will be described.

When the link connection of the coaxial cable modem 79 is continuously disconnected for X seconds in the “authentication completed state” 54, the authentication state storage section 13 of the main terminal 71 deletes the sub-terminal 72 from the state management table 29. In other words, the state is changed to the “unconnected state” 51 shown in FIG. 8 which is a state where actual management is not provided.

Meanwhile, when the link connection of the coaxial cable modem 79 is disconnected in the “authentication completed state” 54 only to be reconnected within a certain amount of time (X seconds), the authentication state storage section 13 of the main terminal 71 maintains the “authentication completed state” 54 in the state management table 29. It is needless to say that the certain amount of time (X seconds) can take any value that is optimal to the system.

With the authentication system according to the present embodiment described above, in the same manner as with each of the other embodiments, link establishment by a sub-terminal becomes completely impossible once the main terminal 71 determines that the sub-terminal is unauthorized and causes a transition to be made to the “unauthorized/disconnect” state. Therefore, since there is no longer a risk that a sub-terminal once denied permission transmits an authentication request to the authentication server 75, it is now possible to significantly reduce the load on the authentication server 75.

In addition, by having the main terminal 71 snoope authentication data from the sub-terminals 72 to 74 thereunder and from the authentication server 75 to manage authentication states, the main terminal 71 automatically registers unauthorized terminals even when a sub-terminal is unauthorized or when a pirate sub-terminal, such as a sub-terminal that sidesteps normal authentication sequences by avoiding authentication or the like, is connected. This eliminates the need for registering authorized terminals or the like in advance, and simplification of management can be achieved.

Furthermore, with the authentication system according to the present third embodiment, by arranging sub-terminals to automatically perform frequency searches when an error state such as an authentication response timeout or a denied permission response occurs during the authentication sequence, it is now possible to automatically take evasive actions in the event that a sub-terminal enters a separate system. Consequently, since there is no longer a need to manage sub-terminals of separate systems as unauthorized terminals and the main terminal 71 now only performs management of truly unauthorized terminals, it is now possible to reduce the load on the main terminal 71 as well.

Moreover, by comparing an address of the authentication server 75, a keyword and a system-unique response value, it is now possible to prevent responses from a spoofing authentication server, and a more robust system can be established.

### Fourth Embodiment

Next, a management method by a main terminal of sub-terminals connected thereunder in an authentication system according to a fourth embodiment of the present invention will be described.

The configuration of the authentication system as well as the configurations of the main terminal 71 and the sub-terminals 72 to 74 according to the present fourth embodiment are the same as those in the first embodiment, and are as illustrated in FIG. 1.

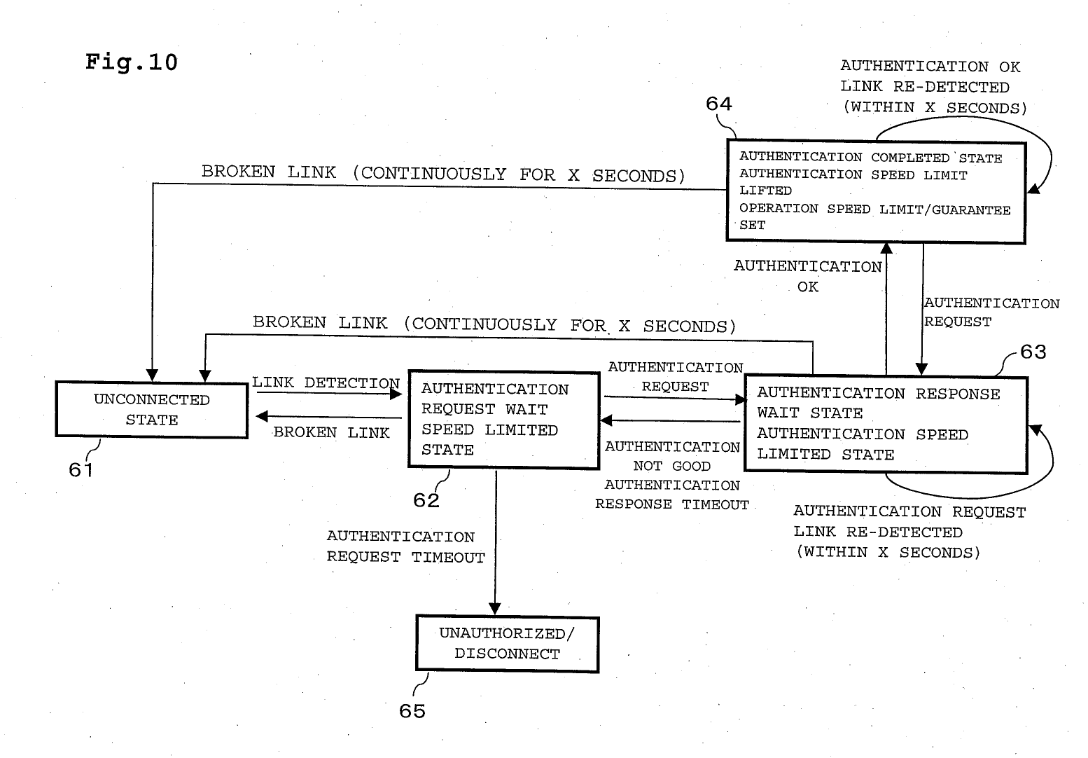

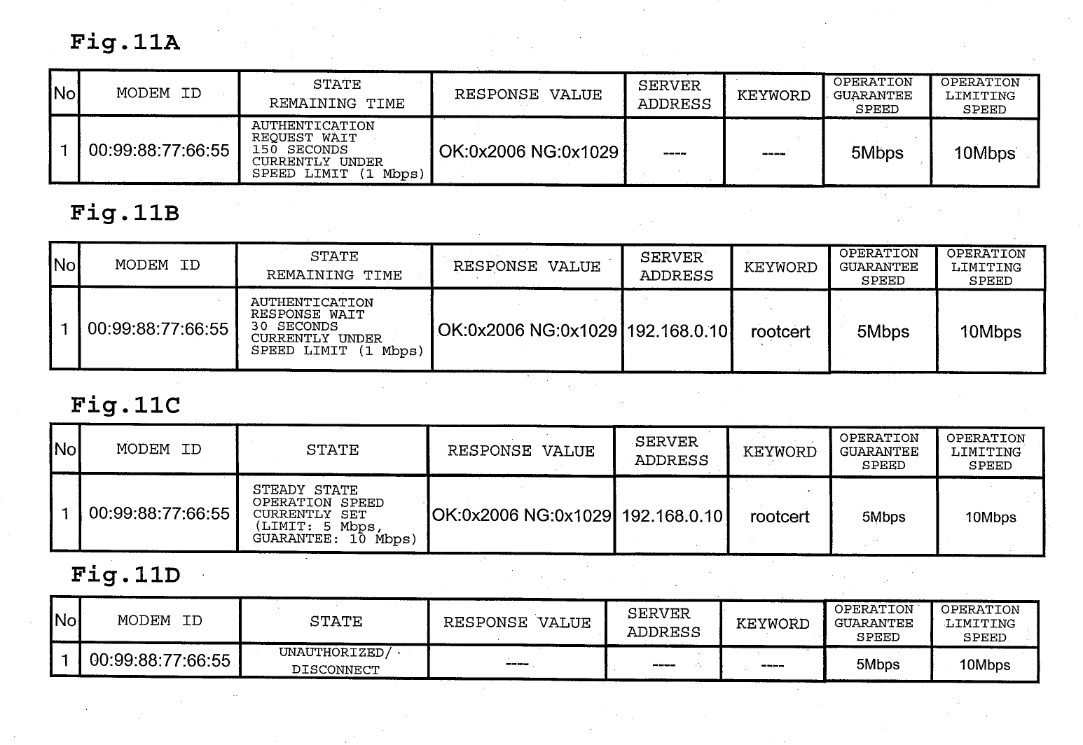

FIG. 10 shows a diagram showing state transitions upon authentication of sub-terminals 72 to 74 connected under and managed by the main terminal 71. FIGS. 11A to 11D show state management tables 29, which are managed by the main terminal 71 at the authentication state storage section 13, of the sub-terminals 72 to 74 connected under the main terminal 71.

A description will be given below which takes as an example a case where the sub-terminal 72 is newly connected to an operating frequency on which the main terminal 71 operates. In this case, the modem ID (here, a MAC address is assumed) of the coaxial cable modem 79 constituting the sub-terminal 72 is assumed to be (00:99:88:77:66:55).

First, operations of the main terminal 71 will be described.

When it is detected by the connection detection section 15 shown in FIG. 2 that the sub-terminal 72 is newly connected to the coaxial I/F 11, the main terminal 71 notifies the connection information to the authentication state storage section 13 via the coaxial control section 14. The authentication state storage section 13 registers the modem ID of the coaxial cable modem 79 in the state management table 29 as shown in FIG. 11A, and changes the transition state of the sub-terminal 72 to an “authentication request wait state” 62 as shown in FIG. 10.

Furthermore, the authentication state storage section 13 calculates the same data as authentication response data created by the authentication server 75 from the modem ID (00:99:88:77:66:55) and which indicates granted permission and denied permission respectively, and registers the authentication response data in “response value” of the state management table 29. In this case, it is assumed that the values of authentication response data indicating granted permission and denied permission are 0x2006 and 0x1029 respectively. Since a calculation method of these response values need only be shared among the authentication server 75, the main terminal 71 and the coaxial cable modem 79, a description thereof will not be given.

Further, with respect to the sub-terminal 72 newly connected under the main terminal 71, the authentication state storage section 13 of the main terminal 71 limits the communication speed for authentication. The authentication state storage section 13 sets a speed limit for authentication (in this case, 1 Mbps) in the state management table 29 as shown in FIG. 11A, and sets the communication speed of the coaxial control section 14 with the sub-terminal 72 connected to the coaxial I/F 11 to 1 Mbps. While the speed limit for authentication is set to 1 Mbps in this case, it is needless to say that the authentication speed limit may be set to any value that is optimal to the system.

The coaxial frequency control section 14 corresponds to an example of the speed limiting unit according to the present invention.

Further, the authentication state storage section 13 also registers a maximum authentication request timeout time (150 seconds), during which it is assumed that the coaxial cable modem 79 newly connected under the main terminal 71 will transmit authentication request data, to the state management table 29 as shown in FIG. 11A. The authentication request timeout time registered in the state management table 29 is counted down, and reset to 150 seconds every time the coaxial cable modem 79 connected under the main terminal 71 retransmits authentication request data. While the maximum authentication request timeout time is set to 150 seconds in this configuration, it is needless to say that this value should represent an optimum time in accordance with the system.

When the authentication state storage section 13 of the main terminal 71 does not receive authentication request data from the newly connected coaxial cable modem 79 within the maximum authentication request timeout time (150 seconds), the authentication state storage section 13 of the main terminal 71 determines that the sub-terminal 72 is an unauthorized terminal that does not conform to the normal authentication sequence, causes a transition of the state of the state management table 29 of the sub-terminal 72 to be made to “unauthorized/disconnect” 65 as shown in FIG. 11D, and disconnects the connection with the target coaxial cable modem 79 at the physical layer using the coaxial control section 14. In addition, the authentication speed limit set to the sub-terminal 72 is also lifted at this point.

In the “authentication request wait state” 62, when the link connection of the coaxial cable modem 79 is disconnected within the maximum authentication request timeout time (150 seconds), the authentication state storage section 13 deletes the sub-terminal 72 from the state management table 29. In other words, the state is changed to the “unconnected state” 61 shown in FIG. 10 which is a state where actual management is not provided. In addition, the authentication speed limit set to the sub-terminal 72 is also lifted at this point.

Next, operations of the sub-terminal 72 connected to the main terminal 71 will be described.

With the coaxial cable modem 79 connected to the main terminal 71, in order to perform device authentication of itself, the authentication data creation section 27 acquires an authentication ID from the authentication ID storage section 28 and creates authentication request data. When the authentication data creation section 27 requests the coaxial transmission/reception processing section 23 to process the created authentication request data, the coaxial transmission/reception processing section 23 transmits the authentication request data to the authentication server 75 via the coaxial cable 85, the distributor 78, the coaxial cable 88 and the main terminal 71.

When the coaxial transmission/reception processing section 23 does not receive authentication response data from the authentication server 75 within a prescribed time (e.g., 5 seconds), the transfer control section 25 of the coaxial cable modem 79 causes the coaxial transmission/reception processing section 23 to retransmit the authentication request data to the authentication server 75. Furthermore, when the number of retransmissions of authentication response data exceeds a prescribed number of times (e.g., five times), the transfer control section 25 causes the coaxial frequency control section 22 to perform a frequency search to attempt connection under another main terminal, not shown, using an operating frequency that differs from the operating frequency used by the main terminal 71.

Next, operations of the main terminal 71 after transmission of authentication request data by the coaxial cable modem 79 will be described.

When the coaxial transmission/reception processing section 19 receives the authentication request data transmitted from the coaxial cable modem 79 via the coaxial I/F 11, the main terminal 71 passes the authentication request data onto the transfer control section 17. The communication data snooping section 18 of the transfer control section 17 snoopes the communication data (in this case, authentication request data) and passes the communication data onto the authentication data analysis section 12. Then, the authentication request data is transferred without modification by the communication transmission/reception processing section 16 to the communication I/F 10.

The authentication data analysis section 12 determines whether the communication data passed from the communication data snooping section 18 is authentication data. If the communication data is not authentication data, no action is taken. If the communication data is authentication data, determination is made on whether the authentication data is authentication request data or authentication response data.

In the case of authentication request data from the newly connected coaxial cable modem 79, the authentication state storage section 13 causes a transition of the state of the sub-terminal 72 in the state management table 29 to be made to an “authentication response wait state” 63 as shown in FIG. 11B. At this point, the authentication speed limit set to the sub-terminal 72 is maintained as-is.

Further, when authentication response data does not arrive from the authentication server 75 after transmission of the authentication request data from the coaxial cable modem 79 newly connected under the main terminal 71, the authentication state storage section 13 registers a time (authentication response timeout: 5 seconds×retransmission: 5 times+margin=30 seconds) during which authentication response timeout is expected by the coaxial cable modem 79 as shown in FIG. 11B. While the authentication response timeout time is set to 30 seconds in this case, it is needless to say that the authentication response timeout time can take any value that is optimal to the system.

When the link connection of the coaxial cable modem 79 is continuously disconnected for X seconds in the “authentication response wait state” 63, the authentication state storage section 13 of the main terminal 71 deletes the sub-terminal 72 from the state management table 29. In other words, a transition is made to the “unconnected state” 61 shown in FIG. 10 which is a state where actual management is not provided.

Meanwhile, when the link connection of the coaxial cable modem 79 is disconnected in the “authentication response wait state” 63 only to be reconnected within a certain amount of time (X seconds), the authentication state storage section 13 of the main terminal 71 maintains the “authentication response wait state” 63 in the state management table 29. It is needless to say that the certain amount of time (X seconds) can take any value that is optimal to the system.

Next, operations of the authentication server 75 will be described.

Upon reception of authentication request data from the coaxial cable modem 79 transferred by the main terminal 71, if the authentication ID included in the authentication request data from the coaxial cable modem 79 is correct, the authentication server 75 calculates authentication response data for granted authentication permission based on the modem ID and transmits the authentication response data to the sub-terminal 72. If the authentication ID is not correct, the authentication server 75 calculates authentication response data for denied authentication permission and transmits the authentication response data to the sub-terminal 72.

The authentication response data indicating granted authentication permission and denied authentication permission calculated at this point by the authentication server 75 is the same as the data calculated when receiving the authentication request data from the coaxial cable modem 79 and stored in the state management table 29 shown in FIG. 11A by the authentication state storage section 13 of the main terminal 71.

Next, operations of the main terminal 71 after transmission of the authentication response data by the authentication server 75 will be described.

When the communication transmission/reception processing section 16 receives the authentication response data transmitted from the authentication server 75 via the communication I/F 10, the main terminal 71 passes the authentication response data onto the transfer control section 17. The communication data snooping section 18 of the transfer control section 17 snoopes the communication data (in this case, authentication response data) and passes the communication data onto the authentication data analysis section 12. Then, the authentication response data is transferred without modification by the coaxial transmission/reception processing section 19 to the coaxial I/F 11.

The authentication data analysis section 12 determines whether the communication data passed from the communication data snooping section 18 is authentication data. If the communication data is not authentication data, no action is taken. If the communication data is authentication data, determination is made on whether the authentication data is authentication request data or authentication response data.

In the case of authentication response data, the authentication state storage section 13 determines which sub-terminal the authentication response data is addressed to. In the case where the authentication response data is for the sub-terminal 72 managed by the state management table 29, the authentication state storage section 13 compares a transmission source address, an authentication data keyword and a response value included in the authentication response data respectively with the address of the authentication server 75, the keyword and the response value registered in the state management table 29 shown in FIG. 11B.

When even one does not match, no action is taken. When all match and the response value is “permission granted”, the authentication state storage section 13 causes a transition of the state of the state management table 29 of the sub-terminal 72 to be made to a “steady state (authentication completed state)” 64 shown in FIG. 11D. In addition, at this point, the authentication state storage section 13 lifts the authentication speed limit set to the sub-terminal 72 and if an operation speed guarantee and/or an operation speed limit have been set, the settings are applied to the sub-terminal 72 as shown in FIG. 11C.

Furthermore, when all match and the response value is “permission denied”, the authentication state storage section 13 once again causes a transition of the state of the state management table 29 of the sub-terminal 72 to be made to the “authentication request wait state” 62 as shown in FIG. 11A. At the same time, the authentication state storage section 13 also registers a maximum authentication request timeout time (150 seconds), during which it is assumed that the coaxial cable modem 79 will transmit authentication request data, to the state management table 29 as shown in FIG. 11A. While the maximum authentication request timeout time is set to 150 seconds in this configuration, it is needless to say that any value that is optimal to the system may be used.

The state is once again returned to the “authentication request wait state” 62 at this point because: if the sub-terminal is authorized, no problems will occur since a frequency search is performed upon reception of a “permission denied” authentication response data, the link is disconnected, and a transition is made to the “unconnected state” 61; while, if the sub-terminal is unauthorized, a frequency search is not performed, an “unauthorized/disconnect” state 65 occurs due to authentication request data timeout, and as a result, an unauthorized sub-terminal can be prevented.

Next, operations of the coaxial cable modem 79 after the main terminal 71 transfers authentication response data from the authentication server 75 will be described.

When the coaxial transmission/reception processing section 23 receives the authentication response data from the authentication server 75 which was transferred by the main terminal 71 via the coaxial I/F 20, the coaxial cable modem 79 passes the authentication response data onto the authentication data analysis section 24.

When the response value of the authentication response data is “permission granted”, the authentication data analysis section 24 instructs the transfer control section 25 to commence transfer and commences communication data transfer, whereby communication by the user terminal 82 connected to the coaxial cable modem 79 is enabled. When the response value of the authentication response data is “permission denied”, the coaxial frequency control section 22 performs a frequency search and proceeds to connect under another main terminal, not shown, using an operating frequency that differs from the operating frequency used by the main terminal 71.

Next, a management method by the main terminal 71 of the state of the sub-terminal 72 after transition to the “steady state (authentication completed state)” 64 will be described.

When the link connection of the coaxial cable modem 79 is continuously disconnected for X seconds in the “authentication completed state” 64, the authentication state storage section 13 of the main terminal 71 deletes the sub-terminal 72 from the state management table 29. In other words, a transition is made to an “unconnected state” 61 shown in FIG. 10 which is a state where actual management is not provided.

Meanwhile, when the link connection of the coaxial cable modem 79 is disconnected in the “authentication completed state”, 64 only to be reconnected within a certain amount of time (X seconds), the authentication state storage section 13 of the main terminal 71 maintains the “authentication completed state”, 64 in the state management table 29. It is needless to say that the certain amount of time (X seconds) can take any value that is optimal to the system.

With the authentication system according to the present embodiment described above, in the same manner as with each of the other embodiments, link establishment by a sub-terminal becomes completely impossible once the main terminal 71 determines that the sub-terminal is unauthorized and causes a transition to be made to the “unauthorized/disconnect” state. Therefore, since there is no longer a risk that a sub-terminal once denied permission transmits an authentication request to the authentication server 75, it is now possible to significantly reduce the load on the authentication server 75.

In addition, by having the main terminal 71 snoope authentication data from the sub-terminals 72 to 74 thereunder and from the authentication server 75 to manage authentication states, the main terminal 71 automatically registers unauthorized terminals even when a sub-terminal is unauthorized or when a pirate sub-terminal, such as a sub-terminal that sidesteps normal authentication sequences by avoiding authentication or the like, is connected. This eliminates the need for registering authorized terminals or the like in advance, and simplification of management can be achieved.

Furthermore, by arranging sub-terminals to automatically perform frequency searches when an error state such as an authentication response timeout or a denied permission response occurs during the authentication sequence, it is now possible to automatically take evasive actions in the event that a sub-terminal enters a separate system. Consequently, since there is no longer a need to manage sub-terminals of separate systems as unauthorized terminals and the main terminal 71 now only performs management of truly unauthorized terminals, it is now also possible to reduce the load on the main terminal 71. Moreover, by comparing an address of the authentication server 75, a keyword and a system-unique response value, it is now possible to prevent responses from a spoofing authentication server, and a more robust system can be established.

In addition, with the authentication system according to the present fourth embodiment, by setting an authentication speed limit on a sub-terminal currently undergoing authentication, allocating only the minimum necessary bands to perform authentication will suffice. Therefore, the impact on bands of authorized sub-terminals already authenticated can be reduced.

### Fifth Embodiment

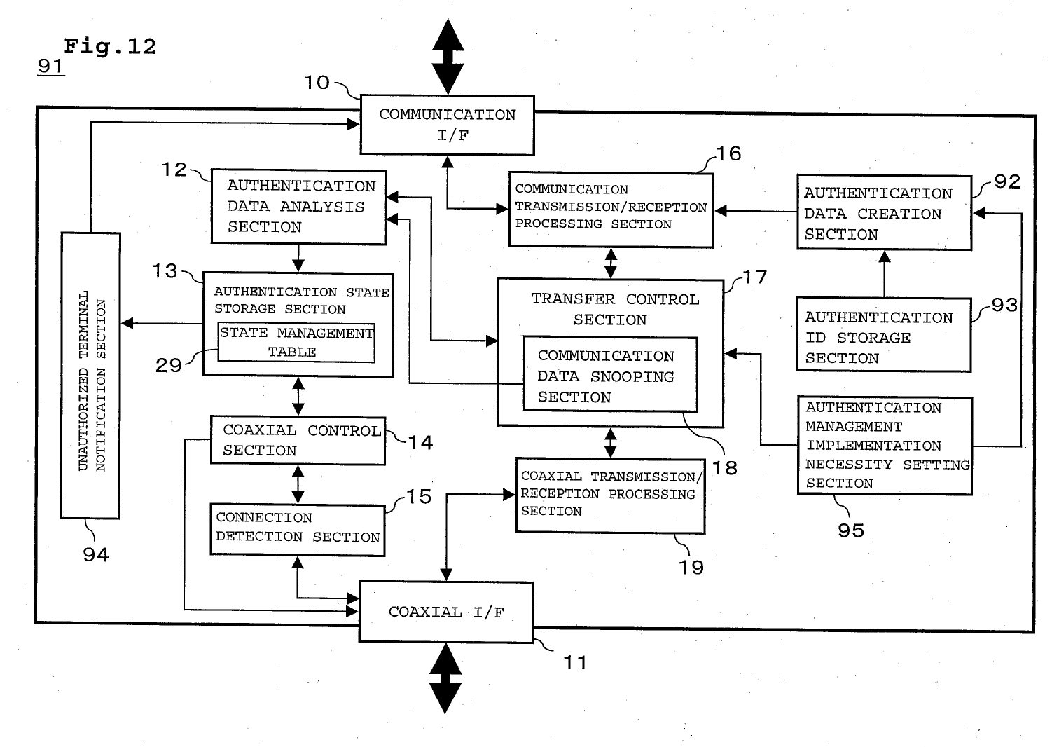

FIG. 12 is an internal configuration diagram of a main terminal of an authentication system according to a fifth embodiment of the present invention.

The configuration of the authentication system according to the present fifth embodiment is similar to those of the first to fourth embodiments, and is as shown in FIG. 1. The only difference from the first to fourth embodiments lies in the configuration of the main terminal. In FIG. 12, like components to FIG. 2 are represented by like reference numerals. A description on components that differ from the main terminal 71 shown in FIG. 2 and operations thereof will be given below.

In addition to the configuration of the main terminal 71 shown in FIG. 2, a main terminal 91 according to the present fifth embodiment is provided with an authentication data creation section 92, an authentication ID storage section 93, an unauthorized terminal notification section 94 and an authentication management implementation necessity setting section 95.

The authentication data creation section 92 and the authentication management implementation necessity setting section 95 respectively correspond to examples of an authentication request data creation unit and an authentication necessity switching section according to the present invention.

The authentication management implementation necessity setting section 95 sets whether the main terminal 91 performs authentication management that has been performed by the main terminal 71 in the first to fourth embodiments. When the authentication management implementation necessity setting section 95 is set to “authentication management implementation”, the main terminal 91 performs authentication management. However, when the authentication management implementation necessity setting section 95 is set to “no authentication management implementation”, the main terminal 91 does not perform authentication management and only performs processing for transfer control. The authentication management implementation necessity setting section 95 is to be set in advance by a user or a system provider, and may be configured either as a hardware-like switch or the like, or as a software-like flag or the like to be set on a memory.

Providing the authentication management implementation necessity setting section 95 enables use of the main terminal 91 according to the present fifth embodiment even in a small-scale system that does not require an authentication server by setting the authentication management implementation necessity setting section 95 to “no authentication management implementation”. In other words, the main terminal 91 according to the present fifth embodiment can be equally applied to systems requiring an authentication server and systems not requiring an authentication server, and may be commoditized among these different systems.

The processing for authentication described below addresses a case where the authentication management implementation necessity setting section 95 is set to “authentication management implementation”. The following processing is not performed when the authentication management implementation necessity setting section 95 is set to “no authentication management implementation”.

The unauthorized terminal notification section 94 transmits authentication states of the sub-terminals 72 to 74 managed by the authentication state storage section 13 using the state management table 29 to the terminal management apparatus 76. For example, when the authentication state storage section 13 detects an unauthorized sub-terminal and a transition is made to “unauthorized/disconnect”, the unauthorized terminal notification section 94 sends SNMP-TRAP or SYSLOG to the terminal management apparatus 76.

As seen, in addition to management performed by the main terminal 71 over the authentication states of the sub-terminals 72 to 74 connected thereunder in the first to fourth embodiments, by arranging the management states to be transmitted to the terminal management apparatus 76, the terminal management apparatus 76 is now capable of automatically detecting unauthorized sub-terminals, thereby preventing terminal management from becoming complicated.

More specifically, in the first to fourth embodiments, the terminal management apparatus 76 manages each sub-terminal 72 to 74 by polling the main terminal 71 at regular intervals or the like, whereas with the authentication system according to the present fifth embodiment, the terminal management apparatus 76 need only receive notifications of authentication states from the main terminal 91. In addition, the terminal management apparatus 76 is now able to detect a new unauthorized terminal as soon as the unauthorized terminal is detected by the main terminal 91.

The authentication data creation section 92 and the authentication ID storage section 93 respectively have the same functions as the authentication data creation section 27 and the authentication ID storage section 28 of the sub-terminals 72 to 74 shown in FIG. 3.

With the main terminal 91 according to the present fifth embodiment, upon activation of the main terminal 91 itself, the authentication data creation section 92 creates authentication request data based on an authentication ID stored in the authentication ID storage section 93. Then, the communication transmission/reception processing section 16 transmits the created authentication request data to the authentication server 75 via the communication I/F 10.

When the communication transmission/reception processing section 16 receives authentication response data corresponding to the authentication request data from the authentication server 75, the authentication data analysis section 12 analyzes the authentication response data.

The authentication data analysis section 12 corresponds to an example of the authentication response data analysis unit according to the present invention.

When the response value of the authentication response data is “permission granted”, the authentication data analysis section 12 instructs the transfer control section 17 to commence transfer and commences communication data transfer between the communication I/F 10 and the coaxial I/F 11. As a result, communication by the user terminals 82 to 84 connected to the sub-terminals 72 to 74 under the main terminal 91 is enabled.

Then, when the main terminal 91 itself is authenticated, the main terminal 91 implements authentication management described in the first to fourth embodiments over the sub-terminals 72 to 74.

The main terminals and the coaxial cable modems in the respective embodiments have been described as being master coaxial cable modems and client coaxial cable modems used when configuring a coaxial home network using a coaxial cable provided for a TV in a residence. However, in addition to a coaxial home network, the present invention can also be applied to other communication systems by providing the same configurations as those of the main terminals and the coaxial cable modems described in the respective embodiments.

For example, the same effects may be achieved by realizing a similar configuration with PLC communication modems using lines for light fixtures in a residence and providing the PLC communication modems with the functions of the main terminals and the coaxial cable modems described in the respective embodiments.

Furthermore, the present invention need not be limited to communication systems in which wired connections are provided between the main terminals and the sub-terminals by coaxial cables or the like, and the present invention may also be applied to communication systems using wireless connection. For example, in the configuration of the conventional wireless communication system shown in FIG. 13, the functions of the main terminals and the coaxial cable modems described in the respective embodiments may be arranged to be respectively provided at the access point 105 and the wireless LAN adapters 110 to 112. In this case, when the access point 105 determines that a wireless LAN adapter is unauthorized, the physical layer with the wireless LAN adapter is disconnected to prevent subsequently accepting SSID authentication from the wireless LAN adapter determined to be unauthorized.

As described above, since the authentication system according to the present invention prevents unauthorized sub-terminals from occupying bands by disabling physical layer connections with the unauthorized sub-terminals, users of authorized sub-terminals do not incur drawbacks. In addition, since unauthorized use of unauthorized sub-terminals is completely eliminated, the load on the servers of a communication system can be reduced. Furthermore, by setting a speed limit on sub-terminals undergoing authentication and restricting bands to only those required for authentication, bands used by authorized sub-terminals are no longer strained. Moreover, since the main terminal is now able to automatically register unauthorized client sub-terminals connected under the main terminal, management can be simplified.

In other words, the authentication system according to the present invention is an authentication system capable of reducing the load on a server of a communication system, eliminating unauthorized client terminals, and automatically registering unauthorized clients.

Since the use of the authentication system according to the present invention simplifies detection and elimination of unauthorized terminals, the authentication system according to the present invention is beneficial to access systems that use coaxial cables such as cable Internet, and can also be applied for the authentication of collateral terminals in a home network where a main contract terminal and collateral terminals are installed in a residence or the like.

A program according to the present invention is a program that causes a computer to execute the functions of all of or a unit of the terminals of the above-described authentication system according to the present invention or the functions of the main terminal according to the present invention, and may be a program that operates in cooperation with a computer.

In addition, the present invention may take the form of a storage medium storing a program that causes a computer to execute the functions of all of or a unit of the terminals of the above-described authentication system according to the present invention or all of or a unit of the functions of all of or a unit of the units which make up the main terminal according to the present invention, and may be a storage medium that is computer-readable and in which the read program cooperates with the computer to execute the functions.

Moreover, “a unit of apparatuses according to the present invention” refers to some apparatuses among the plurality of apparatuses according to the present invention, or a unit of units within one apparatus, or a unit of functions within one unit.

In addition, a computer-readable storage medium storing a program according to the present invention is also included in the present invention.

Furthermore, a program according to the present invention may be used in a mode in which the program is stored in a computer-readable storage medium and operates in cooperation with a computer.

Moreover, a program according to the present invention may also be used in a mode in which the program is transmitted through a transmission medium and read by a computer, whereby the program operates in cooperation with the computer.

Examples of storage media include a ROM.

The above-mentioned computer according to the present invention is not limited to genuine hardware such as a CPU and may take the form of firmware, an OS, or even a peripheral device.

As described above, a configuration of the present invention may either be realized through software or through hardware.

The authentication system and the main terminal according to the present invention have the effect of reducing the load on an authentication server through management simpler than before, and are useful as an authentication system of network devices connected to a network and a main terminal or the like thereof.

What is claimed is:

1. An authentication system comprising:
a main terminal;
one or more sub-terminals connected to the main terminal; and
an authentication server connected to the main terminal and which authenticates whether the sub-terminal is a terminal for which communication permission is granted by exchanging authentication data with the sub-terminal via the main terminal, wherein
the main terminal includes:
a connection control unit that controls physical layer connection with the sub-terminal;
an authentication state table for storing at least ID information of the sub-terminal included in authentication request data transmitted by the sub-terminal to the authentication server when making an authentication request; and
an authentication state control unit which, in the event that an authentication result included in authentication response data transmitted to the sub-terminal by the authentication server in correspondence to the authentication request data transmitted by the sub-terminal to the authentication server indicates that the sub-terminal corresponding to the ID information stored in the authentication state table is a terminal for which permission is denied, causes the connection control unit to disconnect the physical layer connection with the sub-terminal so as to disable link establishment from the sub-terminal.

2. An authentication system comprising:
a main terminal;
one or more sub-terminals connected to the main terminal; and
an authentication server connected to the main terminal and which authenticates whether a sub-terminal is a terminal for which communication permission is granted by exchanging authentication data with the sub-terminal via the main terminal, wherein
the sub-terminal is arranged so that when the sub-terminal establishes a new link with the main terminal, the sub-terminal transmits authentication request data for requesting authentication to the authentication server within a predetermined authentication request timeout period after establishing the link, and
the main terminal includes:
a connection detection unit that detects a connection state with the sub-terminal;
a connection control unit that controls physical layer connection with the sub-terminal; and
an authentication state control unit which, after the connection detection unit detects that a link with the sub-terminal has been newly established, the sub-terminal fails to transmit the authentication request data intended for the authentication server within the predetermined authentication request timeout period, causes the connection control unit to disconnect the physical layer connection with the sub-terminal so as to disable link establishment from the sub-terminal.

3. An authentication system comprising:
a main terminal;
one or more sub-terminals connected to the main terminal; and
an authentication server connected to the main terminal and which authenticates whether a sub-terminal is a terminal for which communication permission is granted by exchanging authentication data with the sub-terminal via the main terminal, wherein
the sub-terminal is arranged so that in the event that an authentication result included in authentication response data received from the authentication server is that of denied permission, after receiving the authentication response data, the sub-terminal disconnects the link with the main terminal within a predetermined denied permission reception timeout period, and
the main terminal includes:
a connection detection unit that detects a connection state with the sub-terminal;
a connection control unit that controls physical layer connection with the sub-terminal;
an authentication state table for storing at least ID information of the sub-terminal included in authentication request data transmitted by the sub-terminal to the authentication server when making an authentication request; and
an authentication state control unit which, in the event that an authentication result included in the authentication response data transmitted to the sub-terminal by the authentication server in correspondence to the authentication request data transmitted by the sub-terminal to the authentication server indicates that the sub-terminal corresponding to the ID information stored in the authentication state table is a terminal for which permission is denied, the authentication state control unit forwards the authentication response data to the sub-terminal, and when the sub-terminal subsequently fails to disconnect the link within the predetermined denied permission reception timeout period, the authentication state control unit causes the connection control unit to disconnect the physical layer connection with the sub-terminal so as to disable link establishment from the sub-terminal.

4. The authentication system according to claim 3, wherein
the sub-terminal includes a frequency control unit that controls an operating frequency used in communication, and
upon receiving the authentication response data in which the authentication result is that of denied permission, the sub-terminal disconnects the link established up to that point with the main terminal in order to connect with another main terminal operating at a different operating frequency.

5. An authentication system comprising:
a main terminal;
one or more sub-terminals connected to the main terminal; and
an authentication server connected to the main terminal and which authenticates whether a sub-terminal is a terminal for which communication permission is granted by exchanging authentication data with the sub-terminal via the main terminal, wherein
the sub-terminal is arranged so that in the event in which, after transmitting authentication request data to the authentication server in order to request authentication, the sub-terminal does not receive authentication response data corresponding to the authentication request data from the authentication server within a predetermined retry request period, the sub-terminal retransmits the authentication request data for a predetermined number of retries within each predetermined retry request period, and in the event that the authentication response data is still not received, the sub-terminal disconnects the link with the main terminal within a predetermined authentication response timeout period starting at the time point of transmission of the first authentication request data, and
the main terminal includes:
a connection detection unit that detects a connection state with the sub-terminal;
a connection control unit that controls physical layer connection with the sub-terminal; and
an authentication state control unit which, in the event that after transferring the first authentication request data from the sub-terminal to the authentication server, the link with the sub-terminal is not disconnected even though the authentication response data intended for the sub-terminal has not been transmitted from the authentication server within the predetermined authentication reception timeout period, causes the connection control unit to disconnect the physical layer connection with the sub-terminal so as to disable link establishment from the sub-terminal.

6. The authentication system according to claim 5, wherein
the sub-terminal includes a frequency control unit that controls an operating frequency used in communication, and
when the sub-terminal does not receive the authentication response data despite retransmitting the authentication request data for the predetermined number of retries, the sub-terminal disconnects the link established up to that point with the main terminal in order to connect with another main terminal operating at a different operating frequency.

7. The authentication system according to claim 1, wherein
the main terminal includes a speed limiting unit capable of limiting the communication speed between the sub-terminal to a slower speed, and
the authentication state control unit is arranged so that, subsequent to detection of an establishment of a new link with the sub-terminal by the connection detection unit and until the sub-terminal is authenticated by the authentication server, the authentication state control unit controls the speed limiting unit so that the communication speed between the main terminal and the sub-terminal becomes slower.

8. The authentication system according to claim 2, wherein
the main terminal includes a speed limiting unit capable of limiting the communication speed between the sub-terminal to a slower speed, and
the authentication state control unit is arranged so that, subsequent to detection of an establishment of a new link with the sub-terminal by the connection detection unit and until the sub-terminal is authenticated by the authentication server, the authentication state control unit controls the speed limiting unit so that the communication speed between the main terminal and the sub-terminal becomes slower.

9. The authentication system according to claim 3, wherein
the main terminal includes a speed limiting unit capable of limiting the communication speed between the sub-terminal to a slower speed, and
the authentication state control unit is arranged so that, subsequent to detection of an establishment of a new link with the sub-terminal by the connection detection unit and until the sub-terminal is authenticated by the authentication server, the authentication state control unit controls the speed limiting unit so that the communication speed between the main terminal and the sub-terminal becomes slower.

10. The authentication system according to claim 5, wherein
the main terminal includes a speed limiting unit capable of limiting the communication speed between the sub-terminal to a slower speed, and
the authentication state control unit is arranged so that, subsequent to detection of an establishment of a new link with the sub-terminal by the connection detection unit and until the sub-terminal is authenticated by the authentication server, the authentication state control unit controls the speed limiting unit so that the communication speed between the main terminal and the sub-terminal becomes slower.

11. The authentication system according to claim 1, comprising
a terminal management apparatus connected to the main terminal and which manages the main terminal and the sub-terminal, wherein
the main terminal includes an unauthorized terminal notification unit which, in the case where the physical layer connection with the sub-terminal is disconnected, assumes that the sub-terminal is an unauthorized terminal and notifies information on the sub-terminal to the terminal management apparatus.

12. The authentication system according to claim 2, comprising
a terminal management apparatus connected to the main terminal and which manages the main terminal and the sub-terminal, wherein
the main terminal includes an unauthorized terminal notification unit which, in the case where the physical layer connection with the sub-terminal is disconnected, assumes that the sub-terminal is an unauthorized terminal and notifies information on the sub-terminal to the terminal management apparatus.

13. The authentication system according to claim 3, comprising
a terminal management apparatus connected to the main terminal and which manages the main terminal and the sub-terminal, wherein
the main terminal includes an unauthorized terminal notification unit which, in the case where the physical layer connection with the sub-terminal is disconnected, assumes that the sub-terminal is an unauthorized terminal and notifies information on the sub-terminal to the terminal management apparatus.

14. The authentication system according to claim 5, comprising
a terminal management apparatus connected to the main terminal and which manages the main terminal and the sub-terminal, wherein
the main terminal includes an unauthorized terminal notification unit which, in the case where the physical layer connection with the sub-terminal is disconnected, assumes that the sub-terminal is an unauthorized terminal and notifies information on the sub-terminal to the terminal management apparatus.

15. The authentication system according to claim 1, wherein
the main terminal includes:
an authentication request data creation unit that creates authentication request data for having the authentication server authenticate the main terminal itself; and
an authentication response data analysis unit that analyzes authentication response data received from the authentication server which corresponds to the authentication request data for having the main terminal itself authenticated, wherein
the authentication response data analysis unit starts transfer control between the authentication server and the sub-terminal after the main terminal itself is authenticated by the authentication server.

16. The authentication system according to claim 2, wherein
the main terminal includes:
an authentication request data creation unit that creates authentication request data for having the authentication server authenticate the main terminal itself; and
an authentication response data analysis unit that analyzes authentication response data received from the authentication server which corresponds to the authentication request data for having the main terminal itself authenticated, wherein
the authentication response data analysis unit starts transfer control between the authentication server and the sub-terminal after the main terminal itself is authenticated by the authentication server.

17. The authentication system according to claim 3, wherein
the main terminal includes:
an authentication request data creation unit that creates authentication request data for having the authentication server authenticate the main terminal itself; and
an authentication response data analysis unit that analyzes authentication response data received from the authentication server which corresponds to the authentication request data for having the main terminal itself authenticated, wherein
the authentication response data analysis unit starts transfer control between the authentication server and the sub-terminal after the main terminal itself is authenticated by the authentication server.

18. The authentication system according to claim 5, wherein
the main terminal includes:
an authentication request data creation unit that creates authentication request data for having the authentication server authenticate the main terminal itself; and
an authentication response data analysis unit that analyzes authentication response data received from the authentication server which corresponds to the authentication request data for having the main terminal itself authenticated, wherein
the authentication response data analysis unit starts transfer control between the authentication server and the sub-terminal after the main terminal itself is authenticated by the authentication server.

19. The authentication system according to claim 15, wherein
the main terminal includes an authentication necessity switching unit that sets the necessity of authentication of the main terminal itself, wherein
when the authentication necessity switching unit is set so that authentication of the main terminal itself is not performed, the authentication response data analysis unit causes transfer of authentication data to be exchanged between the authentication server and the sub-terminal to be performed without performing processing for authentication.

20. The authentication system according to claim 16, wherein
the main terminal includes an authentication necessity switching unit that sets the necessity of authentication of the main terminal itself, wherein
when the authentication necessity switching unit is set so that authentication of the main terminal itself is not performed, the authentication response data analysis unit causes transfer of authentication data to be exchanged between the authentication server and the sub-terminal to be performed without performing processing for authentication.

21. The authentication system according to claim 17, wherein
the main terminal includes an authentication necessity switching unit that sets the necessity of authentication of the main terminal itself, wherein
when the authentication necessity switching unit is set so that authentication of the main terminal itself is not performed, the authentication response data analysis unit causes transfer of authentication data to be exchanged between the authentication server and the sub-terminal to be performed without performing processing for authentication.

22. The authentication system according to claim 18, wherein
the main terminal includes an authentication necessity switching unit that sets the necessity of authentication of the main terminal itself, wherein
when the authentication necessity switching unit is set so that authentication of the main terminal itself is not performed, the authentication response data analysis unit causes transfer of authentication data to be exchanged between the authentication server and the sub-terminal to be performed without performing processing for authentication.

23. The authentication system according to claim 1, wherein
the connection detection unit acquires a MAC address of the sub-terminal upon establishment of the link with the sub-terminal, and
the authentication state control unit notifies the MAC address of a sub-terminal for which a physical layer connection is to be disconnected to the connection control unit in order to disconnect the physical layer connection with the sub-terminal.

24. The authentication system according to claim 2, wherein
the connection detection unit acquires a MAC address of the sub-terminal upon establishment of the link with the sub-terminal, and
the authentication state control unit notifies the MAC address of a sub-terminal for which a physical layer connection is to be disconnected to the connection control unit in order to disconnect the physical layer connection with the sub-terminal.

25. The authentication system according to claim 3, wherein
the connection detection unit acquires a MAC address of the sub-terminal upon establishment of the link with the sub-terminal, and
the authentication state control unit notifies the MAC address of a sub-terminal for which a physical layer connection is to be disconnected to the connection control unit in order to disconnect the physical layer connection with the sub-terminal.

26. The authentication system according to claim 5, wherein
the connection detection unit acquires a MAC address of the sub-terminal upon establishment of the link with the sub-terminal, and
the authentication state control unit notifies the MAC address of a sub-terminal for which a physical layer connection is to be disconnected to the connection control unit in order to disconnect the physical layer connection with the sub-terminal.

27. The authentication system according to claim 1, wherein the main terminal and the sub-terminal is connected by a coaxial cable via a distributor.

28. The authentication system according to claim 2, wherein the main terminal and the sub-terminal is connected by a coaxial cable via a distributor.

29. The authentication system according to claim 3, wherein the main terminal and the sub-terminal is connected by a coaxial cable via a distributor.

30. The authentication system according to claim 5, wherein the main terminal and the sub-terminal is connected by a coaxial cable via a distributor.

31. A main terminal connected between an authentication server that authenticates a sub-terminal by exchanging authentication data and the sub-terminal, and which transfers the authentication data between the authentication server and the sub-terminal, the main terminal comprising:
a connection control unit that controls physical layer connection with the sub-terminal;
an authentication state table for storing at least ID information of the sub-terminal included in authentication request data transmitted by the sub-terminal to the authentication server when making an authentication request; and
an authentication state control unit which, in the event that an authentication result included in authentication response data transmitted to the sub-terminal by the authentication server in correspondence to the authentication request data transmitted by the sub-terminal to the authentication server indicates that the sub-terminal corresponding to the ID information stored in the authentication state table is a terminal for which permission is denied, causes the connection control unit to disconnect the physical layer connection with the sub-terminal so as to disable link establishment from the sub-terminal.
